(19) United States
(12) Patent Application Publication
(10) Pub. No.: US 2023/0015653 A1
(43) Pub. Date: Jan. 19, 2023

(54) HIGH-CAPACITY BATTERY ELECTRODES WITH IMPROVED BINDERS, CONSTRUCTION, AND PERFORMANCE

(71) Applicant: Sila Nanotechnologies, Inc., Alameda, CA (US)

(72) Inventors: Gleb Yushin, Atlanta, GA (US); Adam Kajdos, Alameda, CA (US); Laura Gerber, Oakland, CA (US); Jens Steiger, Alameda, CA (US); Justin Yen, Alameda, CA (US); Justin Doane, Alameda, CA (US); Alexander Jacobs, Oakland, CA (US); Eerik Hantsoo, Oakland, CA (US); Eugene Berdichevsky, Oakland, CA (US)

(21) Appl. No.: 17/935,789

(22) Filed: Sep. 27, 2022

Related U.S. Application Data
(63) Continuation of application No. 15/825,097, filed on Nov. 28, 2017.
(60) Provisional application No. 62/426,977, filed on Nov. 28, 2016.

(51) Int. Cl. H01M 4/62; H01M 10/0587; H01M 4/134; H01M 4/38; H01M 4/66; H01M 10/0525

(52) U.S. Cl. CPC H01M 4/622; H01M 10/0587; H01M 4/134; H01M 4/386; H01M 4/625; H01M 4/661; H01M 4/669; H01M 10/0525; H01M 2004/027

(57) ABSTRACT

An anode material composition is provided for a metal-ion battery that comprises an active material coating, a current conductive current collector, and a conductive interlayer coupling the active material coating to the current collector. The active material coating may have a capacity loading of at least 2 mAh/cm² and comprise active material particles that exhibit volume expansion in the range of about 8 vol. % to about 160 vol. % during a first charge-discharge cycle and volume expansion in the range of about 4 vol. % to about 50 vol. % during one or more subsequent charge-discharge cycles.

### CROSS-REFERENCE TO RELATED APPLICATIONS

The present application for patent is a Continuation of U.S. patent application Ser. No. 15/825,097, entitled “HIGH-CAPACITY BATTERY ELECTRODES WITH IMPROVED BINDERS, CONSTRUCTION, AND PERFORMANCE,” filed Nov. 28, 2017, which in turn claims the benefit of U.S. Provisional Application No. 62/426,977, entitled “High-Capacity Battery Electrodes with Improved Binders, Construction, and Performance,” filed Nov. 28, 2016, each of which is expressly incorporated herein by reference in its entirety.

### BACKGROUND

### Field

The present disclosure relates generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for potential applications in low- or zero-emission, hybrid-electrical or fully-electrical vehicles, consumer electronics, energy-efficient cargo ships and locomotives, aerospace applications, and power grids. In particular, further improvements are desired for various rechargeable batteries, such as rechargeable metal and metal-ion batteries (such as rechargeable Li and Li-ion batteries, rechargeable Na and Na-ion batteries, rechargeable Mg and Mg-ion batteries, etc.), rechargeable aqueous batteries, rechargeable alkaline batteries, rechargeable metal hydride batteries, and lead acid batteries, to name a few.

A broad range of active (charge-storing) materials, a broad range of polymer binders, a broad range of conductive additives and various mixing recipes may be utilized in the construction of battery electrodes. However, for improved electrode performance (low and stable resistance, high cycling stability, high rate capability, etc.), the binders, additives, and mixing protocols need to be carefully selected for specific types and specific sizes of active particles. In many cases, these selections are not trivial and can be counter-intuitive.

In many different types of rechargeable batteries, charge storing materials may be produced as high-capacity (nano)composite powders, which exhibit moderately high volume changes (e.g., an increase of 8%-160% by volume) during the first charge-discharge cycle and moderate volume changes (e.g., 5-50 vol. %) during the subsequent charge-discharge cycles. A subset of such charge-storing particles includes particles with an average size in the range from around 0.2 to around 20 microns. Such a class of charge-storing particles offers great promises for scalable manufacturing and achieving high cell-level energy density and other electrode performance characteristics. However, such particles are relatively new and their formation into electrodes using conventional binders, conductive additives, and mixing protocols may result in poor electrode performance characteristics and limited cycle stability. The electrode performance may become particularly poor when the electrode capacity loading becomes moderate (e.g., 2-4 mAh/cm²) or even more so when the electrode capacity loading becomes high (e.g., 4-10 mAh/cm²). Higher capacity loading, however, is generally desired for increasing cell energy density and reducing cell manufacturing costs.

Examples of materials that exhibit moderately high volume changes (e.g., 8-160 vol. %) during the first charge-discharge cycle and moderate volume changes (e.g., 5-50 vol. %) during the subsequent charge-discharge cycles include (nano)composites comprising so-called conversion-type active electrode materials (which include both so-called chemical transformation and so-called “true conversion” sub-classes) and so-called alloying-type active electrode materials. In the case of metal-ion batteries (such as Li-ion batteries), examples of such conversion-type active electrode materials include, but are not limited to, metal fluorides (such as lithium fluoride, iron fluoride, cupper fluoride, bismuth fluorides, their mixtures and alloys, etc.), metal chlorides, metal iodides, metal chalcogenides (such as sulfides, including lithium sulfide and other metal sulfides), sulfur, metal oxides (including lithium oxide), metal nitrides, metal phosphides (including lithium phosphide), metal hydrides, and others. In the case of metal-ion batteries (such as Li-ion batteries), examples of such alloying-type electrodes include, but are not limited to, silicon, germanium, antimony, aluminum, magnesium, zinc, gallium, arsenic, phosphorous, silver, cadmium, indium, tin, lead, bismuth, their alloys, and others. These materials may offer higher gravimetric and volumetric capacity than so-called intercalation-type electrodes used in commercial Li-ion batteries. Conversion-type electrodes are also commonly used in various aqueous batteries, such as alkaline batteries, metal hydride batteries, lead acid batteries, etc. These include, but are not limited to, various metals (such as iron, zinc, cadmium, lead, indium, etc.), metal oxides, metal hydroxides, metal oxyhydroxides, and metal hydrides, to name a few.

In addition to the needed improvement(s) in electrode formulations, an improvement in separators is also needed for better cell-level design.

Accordingly, there remains a need for improved batteries, components, and other related materials and manufacturing processes.

### SUMMARY

Embodiments disclosed herein address the above stated needs by providing improved batteries, components, and other related materials and manufacturing processes.

As an example, an anode material composition is provided for a metal-ion battery that comprises an active material coating, a current conductive current collector, and a conductive interlayer coupling the active material coating to the current collector. The active material coating may have a capacity loading of at least 2 mAh/cm² and comprise active material particles that exhibit volume expansion in the range of about 8 vol. % to about 160 vol. % during a first charge-discharge cycle and volume expansion in the range of about 4 vol. % to about 50 vol. % during one or more subsequent charge-discharge cycles.

In some designs, the active material coating capacity may be greater than about 600 mAh/g. In some designs, the active material coating may comprise a silicon-based active material, and the metal-ion battery may be a Li-ion battery. In some designs, the active material coating may comprise carbon nanotubes as conductive additives. In some designs, the active material coating may comprise less than 2 wt. % of conductive additives.

In some designs, the current collector may be a copper alloy comprising less than 99 wt. % copper. In some designs, the current collector may comprise nickel in an amount from about 0.5 wt. % to about 100 wt. %. In some designs, the current collector may comprise stainless steel. In some designs, the current collector may be a composite material comprising a plurality of layers. In some designs, the current collector may be a porous material comprising pores. In some designs, the current collector may comprise one or more mechanical reinforcement additives comprising nanowires, nanotubes, nanoflakes, or nanofibers.

In some designs, the interlayer may comprise carbon. For example, the interlayer may comprise carbon nanotubes. In some designs, the interlayer may comprise one or more polymers. The one or more polymers may comprise, for example, polyvinyl alcohol or an electrically-conductive polymer. The one or more polymers may comprise, for example, a co-polymer or a mixture of two or more polymers.

In some designs, the active material coating may comprise a first binder and the interlayer may comprise a second binder having the same composition as the first binder. For example, the first binder and the second binder may comprise the same polymer. In some designs, the active material coating and the interlayer may each comprise at least one water-soluble polymer binder that has a degree of hydrolysis greater than about 94%.

In some designs, the active material particles may be substantially spherical in shape and have a particle size distribution with a coefficient of variance that is less than about 0.2. In some designs, the coefficient of variance may be less than about 0.1. In some designs, the active material particles may be substantially spherical in shape and arranged to form a colloidal crystal structure having a grain size that is greater than about 50% of the active material coating thickness. In some designs, the active material particles may be substantially spherical in shape and have an average spacing between their outer surfaces in the active material coating that is greater than (i) about 10% of their diameter prior to the first charge-discharge cycle or (ii) about 30% of their changes in diameter during the first charge-discharge cycle.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example (e.g., Li-ion) battery in which the components, materials, methods, and other techniques described herein, or combinations thereof, may be applied according to various embodiments.

FIG. 2 illustrates an example of the formation of an electrode comprising an infiltration of the second binder into a preformed electrode.

FIG. 3 illustrates an example of the formation of an electrode comprising uniformly distributed spacing between active (nano)composite particles, which are electrically connected to each other using conductive additives.

FIG. 4 illustrates an example of the formation of an electrode comprising an interlayer between the metal current collector and the active material coating.

FIG. 5 illustrates an example of the formation of an electrode comprising an interlayer between the metal current collector and the active material coating, where the current collector comprises pores and reinforcement fibers.

FIG. 6 illustrates an example of a functionalization of carbon materials by reaction with an aryl diazonium.

FIG. 7 illustrates an example of a functionalization of carbon materials by reaction with an aldehyde and amino acid.

FIG. 8 illustrates an example of an esterification reaction between an acid group on the carbon surface of the active particles and a PVA binder.

FIG. 9 illustrates an example of a reaction between an azide and an alkyne to form a triazole to link active particles and conductive (e.g., carbon) additive.

FIG. 10 illustrates an example of crosslinking between the active particles and a binder by an esterification reaction with citric acid.

FIG. 11 illustrates an example of crosslinking between active particles and conductive carbon additive using 1,3-cycloaddition of surface azides with 1,4-diethynylbenzene.

FIGS. 12A and 12B illustrate an example of stable performance achieved in high capacity Si-comprising anode with PVA binder and SWCNT conductive additives as tested in matched full cell with lithium iron phosphate cathode.

FIG. 13 illustrate an example of ordered straight pores in an electrode formed with uniformly sized near-spherical particles

FIGS. 14A and 14B illustrate examples of the formation of an electrode comprising straight pores (channels) and colloidal crystals structure of spherical active (nano)composite particles.

FIG. 15 illustrate an example process of the lamination of the suitable separator into the electrode prior to cutting into a proper shape to use in cells.

FIG. 16 illustrate an example process where a separator layer is deposited onto a pre-cut electrode using a sprayer.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

While the description below may describe certain examples in the context of Li and Li-ion batteries (for brevity and convenience, and because of the current popularity of Li technology), it will be appreciated that various aspects may be applicable to other rechargeable and primary batteries (such as Na-ion, Mg-ion, and other metal-ion batteries, alkaline batteries, etc.). Further, while the description below may also describe certain examples of the material formulations in a Li-free state (for example, as in silicon-comprising nanocomposite anodes), it will be appreciated that various aspects may be applicable to Li-containing electrodes (for example, lithiated Si anodes, lithiated metal fluorides (e.g., mixtures of LiF and metals such as Cu, Fe, Cu—Fe alloys, etc.), Li₂S, etc.).

Further, while the description below may describe certain examples in the context of some specific alloying-type and conversion-type chemistries of anode and cathode active materials for Li-ion batteries (such as silicon-comprising anodes or metal fluoride-comprising or lithium sulfide-comprising cathodes), it will be appreciated that various aspects may be applicable to other chemistries for Li-ion batteries (e.g., other conversion-type and alloying-type electrodes as well as various intercalation-type electrodes) as well as to other battery chemistries. In the case of metal-ion batteries (such as Li-ion batteries), examples of other suitable conversion-type electrodes include, but are not limited to, metal chlorides, metal iodides, sulfur, selenium, metal oxides, metal nitrides, metal phosphides, metal hydrides, and others.

During battery (such as a Li-ion battery) operation, conversion materials change (convert) from one crystal structure to another (hence the name “conversion”-type). During (e.g., Li-ion) battery operation, Li ions are inserted into alloying type materials forming lithium alloys (hence the name “alloying”-type). Sometimes, “alloying”-type electrode materials are considered to be a sub-class of “conversion”-type electrode materials.

While the description below may describe certain examples in the context of metal-ion batteries, other conversion-type electrodes that may benefit from various aspects of the present disclosure include various chemistries used in a broad range of aqueous batteries, such as alkaline batteries, metal hydride batteries, lead acid batteries, etc. These include, but are not limited to, various metals (such as iron, zinc, cadmium, lead, indium, etc.), metal oxides, metal hydroxides, metal oxyhydroxides, and metal hydrides, to name a few.

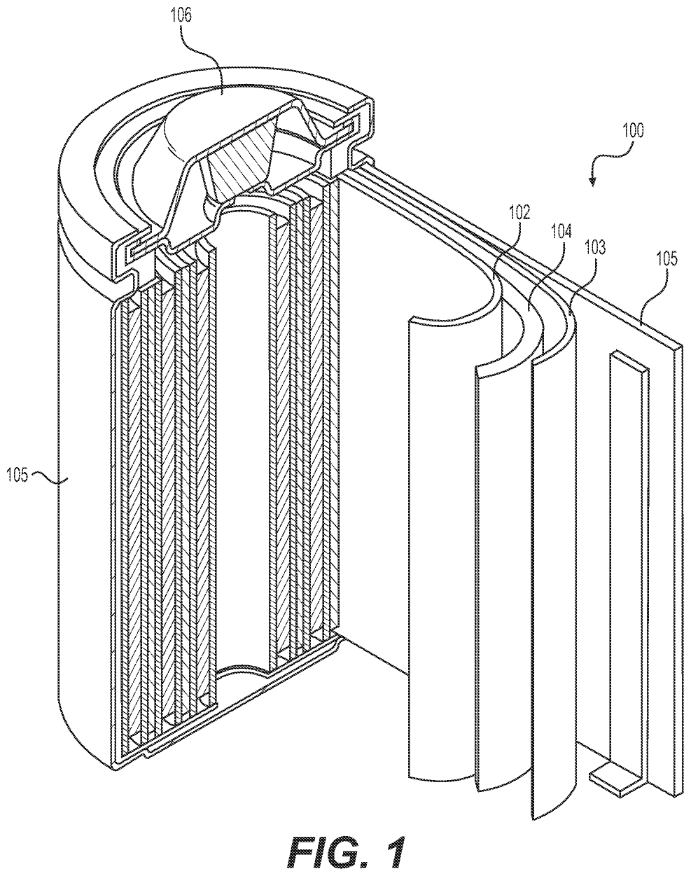

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (not shown) impregnating the separator 104, a battery case 105, and a sealing member 106 sealing the battery case 105.

Both liquid and solid electrolytes may be used for the designs herein. Conventional electrolytes for Li or Na-based batteries of this type are generally composed of a single Li or Na salt (such as LiPF₆ for Li-ion batteries and NaPF₆ or NaClO₄ salts for Na-ion batteries) in a mixture of organic solvents (such as a mixture of carbonates). Other common organic solvents include nitriles, esters, sulfones, sulfoxides, phosphorous-based solvents, silicon-based solvents, ethers, and others. Such solvents may be modified (e.g., be sulfonated or fluorinated). The electrolytes may also comprise ionic liquids (in some designs, neutral ionic liquids; in other designs, acidic and basic ionic liquids). The electrolytes may also comprise mixtures of various salts (e.g., mixtures of several Li salts or mixtures of Li and non-Li salts for rechargeable Li and Li-ion batteries).

In the case of aqueous Li-ion (or aqueous Na-ion, K-ion, Ca-ion, etc.) batteries, electrolytes may include a solution (e.g., aqueous solution or mixed aqueous-organic solution) of inorganic Li (or Na, K, Ca, etc.) salt(s) (such as Li₂SO₄, LiNO₃, LiCl, LiBr, Li₃PO₄, H₂LiO₄P, C₂F₃LiO₂, C₂F₃LiO₃S, Na₂O₃Se, Na₂SO₄, Na₂O₇Si₃, Na₃O₉P₃, C₂F₃NaO₂, etc.). These electrolytes may also comprise solutions of organic Li (or Na, K, Ca, etc.) salts, such as (listed with respect to Li for brevity) metal salts of carboxylic acids (such as HCOOLi, CH₃COOLi, CH₃CH₂COOLi, CH₃(CH₂)₂COOLi, CH₃(CH₂)₃COOLi, CH₃(CH₂)₄COOLi, CH₃(CH₂)₅COOLi, CH₃(CH₂)₆COOLi, CH₃(CH₂)₇COOLi, CH₃(CH₂)₈COOLi, CH₃(CH₂)₉COOLi, CH₃(CH₂)₁₀COOLi, CH₃(CH₂)₁₁COOLi, CH₃(CH₂)₁₂COOLi, CH₃(CH₂)₁₃COOLi, CH₃(CH₂)₁₄COOLi, CH₃(CH₂)₁₅COOLi, CH₃(CH₂)₁₆COOLi, CH₃(CH₂)₁₇COOLi, CH₃(CH₂)₁₈COOLi and others with the formula CH₃(CH₂)xCOOLi, where x ranges up to 50); metal salts of sulfonic acids (e.g., RS(═O)₂—OH, where R is a metal salt of an organic radical, such as a CH₃SO₃Li, CH₃CH₂SO₃Li, C₆H₅SO₃Li, CH₃C₆H₄SO₃Li, CF₃SO₃Li, [CH₂CH(C₆H₄)SO₃Li]ₙ and others) and various other organometalic reagents (such as various organilithium reagents), to name a few. Such solutions may also comprise mixtures of inorganic and organic salts, various other salt mixtures (for example, a mixture of a Li salt and a salt of non-Li metals and semimetals), and, in some cases, hydroxide(s) (such as LiOH, NaOH, KOH, Ca(OH)₂, etc.), and, in some cases, acids (including organic acids). In some designs, such aqueous electrolytes may also comprise neutral or acidic or basic ionic liquids (e.g., from approximately 0.00001 wt. % to approximately 40 wt. % relative to the total weight of electrolyte). In some designs, such “aqueous” (or water containing) electrolytes may also comprise organic solvents (e.g., from approximately 0.00001 wt. % to approximately 40 wt. % relative to the total weight of electrolyte), in addition to water. Illustrative examples of suitable organic solvents may include carbonates (e.g., propylene carbonate, ethylene carbonate, diethyl carbonate, dimethyl carbonate, ethyl methyl carbonate, fluoriethylene carbonate, vinylene carbonate, and others), various nitriles (e.g., acetonitrile, etc.), various esters, various sulfones (e.g., propane sulfone, etc.), various sultones, various sulfoxides, various phosphorous-based solvents, various silicon-based solvents, various ethers, and others.

A common salt used in a Li-ion battery electrolyte, for example, is LiPF₆, while less common salts include lithium tetrafluoroborate (LiBF₄), lithium perchlorate (LiClO₄), lithium bis(oxalato)borate (LiB(C₂O₄)₂, lithium difluoro(oxalate)borate (LiBF₂(C₂O₄)), various lithium imides (such as SO₂FN⁻(Li+)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), and others. Electrolytes for certain Mg-ion, K-ion, Ca-ion, and Al-ion batteries may be more exotic as these batteries are in earlier stages of development. Electrolytes for these battery types may comprise different salts and solvents (in some cases, ionic liquids may replace organic solvents for certain applications).

Some electrolytes in aqueous batteries (such as alkaline batteries, including nickel-metal hydride batteries) may comprise an alkaline solution (for example, a mixture of KOH and LiOH solutions). Some electrolytes in aqueous batteries (such as lead acid batteries) may comprise an acidic aqueous solution (for example, H₂SO₄ aqueous solution). Some electrolytes in aqueous batteries may comprise an organic solvent as an additive. Some electrolytes in aqueous batteries may comprise two or more organic solvent(s) or ionic liquid(s) as additive(s) or substantial components of the electrolyte.

Conventional electrodes utilized in Li-ion batteries may be produced by (i) formation of a slurry comprising active materials, conductive additives, binder solutions and, in some cases, surfactant or other functional additives; (ii) casting a slurry onto a metal foil (e.g., Cu foil for most anodes and Al foil for most cathodes); and (iii) drying the casted electrodes to completely evaporate the solvent.

Conventional cathode materials utilized in Li-ion batteries are of an intercalation-type. Metal ions are intercalated into and occupy the interstitial positions of such materials during the charge or discharge of a battery. Such cathodes experience very small volume changes when used in electrodes. Such cathodes also may exhibit high density (e.g., 3.8-6 g/cm³) and are relatively easy to mix in slurries. Polyvinylidene fluoride, or polyvinylidene difluoride (PVDF), is a common binder used in these electrodes. Carbon black is a common conductive additive used in these electrodes. However, such cathodes exhibit relatively small gravimetric and volumetric capacities (e.g., less than 220 mAh/g and less than 1000 mAh/cm³, respectively).

Conversion-type cathode materials for rechargeable Li-ion or Li batteries may offer higher energy density, higher specific energy, or higher specific or volumetric capacities compared to intercalation-type cathode materials.

For example, fluoride-based cathodes may offer high technological potential due to their high capacities, in some cases exceeding 300 mAh/g (greater than 1200 mAh/cm³ at the electrode level). For example, in a Li-free state, FeF₃ offers a theoretical specific capacity of 712 mAh/g; FeF₂ offers a theoretical specific capacity of 571 mAh/g; MnF₃ offers a theoretical specific capacity of 719 mAh/g; CuF₂ offers a theoretical specific capacity of 528 mAh/g; NiF₂ offers a theoretical specific capacity of 554 mAh/g; PbF₂ offers a theoretical specific capacity of 219 mAh/g; BiF₃ offers a theoretical specific capacity of 302 mAh/g; BiF₅ offers a theoretical specific capacity of 441 mAh/g; SnF₂ offers a theoretical specific capacity of 342 mAh/g; SnF₄ offers a theoretical specific capacity of 551 mAh/g; SbF₃ offers a theoretical specific capacity of 450 mAh/g; SbF₅ offers a theoretical specific capacity of 618 mAh/g; CdF₂ offers a theoretical specific capacity of 356 mAh/g; and ZnF₂ offers a theoretical specific capacity of 519 mAh/g. Mixtures (for example, in the form of alloys) of fluorides may offer a theoretical capacity approximately calculated according to the rule of mixtures. In an example, mixed metal fluorides may be used to facilitate higher rates, lower resistance, higher practical capacity, and/or longer stability. In a fully lithiated state, metal fluorides convert to a composite comprising a mixture of metal and LiF clusters (or nanoparticles). Examples of the overall reversible reactions of the conversion-type metal fluoride cathodes may include 2Li+CuF₂↔2LiF+Cu for CuF₂-based cathodes or 3Li+FeF₃↔3LiF+Fe for FeF₃-based cathodes). It will be appreciated that metal fluoride-based cathodes may be prepared in both Li-free or partially lithiated or fully lithiated states.

Another example of a conversion-type cathode (or, in some cases, anode) material is sulfur (S) (in a Li-free state) or lithium sulfide (Li₂S, in a fully lithiated state). In order to reduce dissolution of active material during cycling, to improve electrical conductivity, or to improve mechanical stability of S/Li₂S electrodes, one or more embodiments may utilize porous S, Li₂S, porous S—C(nano)composites, Li₂S—C (nano)composites, Li₂S-metal oxide (nano)composites, Li₂S—C-metal oxide (nano)composites, Li₂S—C-metal sulfide (nano)composites, Li₂S-metal sulfide (nano)composites, Li₂S—C-mixed metal oxide (nano)composites, Li₂S—C-mixed metal sulfide (nano)composites, porous S-polymer (nano)composites, or other composites or (nano)composites comprising S or Li₂S, or both. In some embodiments, such (nano)composites may comprise conductive carbon. In some embodiments, such (nano)composites may comprise metal oxides or mixed metal oxides. In some embodiments, such (nano)composites may comprise metal sulfides or mixed metal sulfides. In some examples, mixed metal oxides or mixed metal sulfides may comprise lithium metal. In some examples, mixed metal oxides may comprise titanium metal. In some examples, lithium-comprising metal oxides or metal sulfides may exhibit a layered structure. In some examples, metal oxides or mixed metal oxides or metal sulfides or mixed metal sulfides may be both ionically and electrically conductive. In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within 1.5-3.8 V vs. Li/Li⁺).

However, many conversion-type electrodes used in Li-ion batteries suffer from performance limitations. Formation of (nano)composites for use as composite cathode materials may, at least partially, overcome such limitations. For example, (nano)composites used as composite cathode materials may offer reduced voltage hysteresis, improved capacity utilization, improved rate performance, improved mechanical and sometimes improved electrochemical stability, reduced volume changes, and other positive attributes. Examples of such composite cathode materials include, but are not limited to, LiF—Cu—Fe—C nanocomposites, LiF—Cu—CuO—C nanocomposites, LiF—Cu—Fe—CuO—C nanocomposites, LiF—Cu—Fe—CuO—Fe₂O₃—C nanocomposites, FeF₂—C nanocomposites, FeF₂—Fe₂O₃—C nanocomposites, FeF₃—C nanocomposites, FeF₃—Fe₂O₃—C nanocomposites, CuF₂—C nanocomposites, CuO—CuF₂—C nanocomposites, LiF—Cu—C nanocomposites, LiF—Cu—C-polymer nanocomposites, LiF—Cu—CuO—C-polymer nanocomposites, LiF—Cu-metal-polymer nanocomposites, and many other porous nanocomposites comprising LiF, FeF₃, FeF₂, MnF₃, CuF₂, NiF₂, PbF₂, BiF₃, BiF₅, CoF₂, SnF₂, SnF₄, SbF₃, SbF₅, CdF₂, or ZnF₂, or other metal fluorides or their alloys or mixtures and optionally comprising metal oxides and their alloys or mixtures. In some examples, metal sulfides or mixed metal sulfides may be used instead of or in addition to metal oxides in such (nano)composites. In some examples, metal fluoride nanoparticles may be infiltrated into the pores of porous carbon (for example, into the pores of activated carbon particles) to form these metal-fluoride-C nanocomposites. In some examples, such composite particles may also comprise metal oxides (including mixed metal oxides or metal oxyfluorides or mixed metal oxyfluorides) or metal sulfides (including mixed metal sulfides). In some examples, mixed metal oxides or mixed metal sulfides may comprise lithium metal. In some examples, lithium-comprising metal oxides or metal sulfides may exhibit a layered structure. In some examples, metal oxides or mixed metal oxides or metal sulfides or mixed metal sulfides may be both ionically and electrically conductive. In some examples, various intercalation-type active materials may be utilized instead of or in addition to metal oxides or metal sulfides. In some embodiments, such an intercalation-type active material exhibits charge storage (e.g., Li insertion/extraction capacity) in the same potential range as metal fluorides or in the nearby potential range (e.g., within 1.5-4.2 V vs. Li/Li⁺). In some examples, such metal oxides may encase the metal fluorides and reduce or prevent direct contact of metal fluorides (or oxyfluorides) with liquid electrolytes (e.g., in order to reduce or prevent metal corrosion and dissolution during cycling). In some examples, nanocomposite particles may comprise carbon shells or carbon coatings. Such a coating may enhance electrical conductivity of the particles and may also prevent (or help to reduce) undesirable direct contact of metal fluorides (or oxyfluorides) with liquid electrolytes. Such fluoride-comprising (nano)composite particles may be used in nonlithiated, fully lithiated and partially lithiated states.

In particular, high-capacity (nano)composite cathode powders, which exhibit moderately high volume changes (e.g., 8-160 vol. %) during the first cycle, moderate volume changes (e.g., 4-50 vol. %) during the subsequent charge-discharge cycles, and an average size (e.g., a diameter in the case of spherical or near-spherical particles) in the range from around 0.2 to around 20 microns may be suitable for battery applications in terms of manufacturability and performance characteristics. Furthermore, in an example, a near-spherical (spheroidal) shape of the nanocomposite particles used in the (nano)composite cathode powder may improve rate performance and volumetric capacity of the electrodes. In addition to improvements that may be achieved with the formation and utilization of such conversion-type nanocomposite cathode materials, improvements in cell performance characteristics may be achieved with improved composition and preparation of electrodes. The relatively low density of such conversion-type nanocomposite cathode materials (e.g., 1-3.8 g/cc) may make uniform slurry mixing, coating deposition, and calendaring (electrode densification) more challenging. In addition, such conversion-type nanocomposite cathode materials may be coated with a carbon outer layer, which is less polar compared to conventional intercalation-type cathodes and thus may make such nanocomposite particles used in the (nano)composite cathode powder more difficult to disperse, particularly in polar solvents.

Conventional anode materials utilized in Li-ion batteries are also of an intercalation-type. Metal ions are intercalated into and occupy the interstitial positions of such materials during the charge or discharge of a battery. Such anodes experience relatively small volume changes when used in electrodes. Polyvinylidene fluoride, or polyvinylidene difluoride (PVDF), and carboxymethyl cellulose (CMC) are two common binders used in these electrodes. Carbon black is a common conductive additive used in these electrodes. However, such anodes exhibit relatively small gravimetric and volumetric capacities (e.g., less than 370 mAh/g rechargeable specific capacity in the case of graphite- or hard carbon-based anodes and less than 600 mAh/cm³ rechargeable volumetric capacity).

Alloying-type anode materials for use in Li-ion batteries offer higher gravimetric and volumetric capacities compared to intercalation-type anodes. For example, silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electric and ionic conductivity of Si is lower than that of graphite. In some embodiments, formation of (nano)composite Si-comprising particles (including, but not limited to Si—C composites, Si-metal composites, Si-polymer composites, Si-ceramic composites, or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells.

In addition to Si-comprising nanocomposite anodes, other examples of such nanocomposite anodes comprising alloying-type active materials include, but are not limited to, those that comprise germanium, antimony, aluminum, magnesium, zinc, gallium, arsenic, phosphorous, silver, cadmium, indium, tin, lead, bismuth, their alloys, and others.

In addition to (nano)composite anodes comprising alloying-type active materials, other suitable types of high capacity (nano)composite anodes may comprise metal oxides (including silicon oxide, lithium oxide, etc.), metal nitrides, metal phosphides (including lithium phosphide), metal hydrides, and others.

In particular, high-capacity (nano)composite anode powders, which exhibit moderately high volume changes (e.g., 8-160 vol. %) during the first cycle, moderate volume changes (e.g., 4-50 vol. %) during the subsequent charge-discharge cycles and an average size in the range from around 0.2 to around 40 microns (e.g., from around 0.4 to around 20 microns) may be suitable for battery applications in terms of manufacturability and performance characteristics. In an example, (nano)composite anode powders comprising Si in various battery implementations, such as batteries with a specific capacity in the range from about 500 mAh/g to about 3000 mAh/g. In some designs, the specific capacity of such powders may range from about 600 mAh/g to about 2000 mAh/g. In an example, an anode coating layer may exhibit volumetric capacity (e.g., after lithiation and the resulting expansion) in the range from about 600 mAh/cc to about 1800 mAh/cc (in some designs, from about 700 mAh/cc to about 1400 mAh/cc). Electrodes with electrode capacity loading from moderate (e.g., 2-4 mAh/cm²) to high (e.g., 4-10 mAh/cm²) are also suitable for use in cells. Furthermore, in an example, a near-spherical (spheroidal) shape of these nanocomposite particles used in the (nano)composite anode powder may improve rate performance and volumetric capacity of the electrodes. In addition to some improvements that may be achieved with the formation and utilization of such alloying-type or conversion-type nanocomposite anode materials, improvements in cell performance characteristics may be achieved with improved composition and preparation of electrodes. The relatively low density of such conversion-type nanocomposite anode materials (e.g., 0.5-2.5 g/cc) may make uniform slurry mixing, coating deposition, and calendaring (electrode densification) more challenging. In addition, such conversion-type nanocomposite anode materials may be coated with a carbon outer layer, which is less polar compared to conventional intercalation-type cathodes and thus may make such nanocomposite particles used in the (nano)composite anode powder more difficult to disperse in some solvents.

However, high-capacity (nano)composite anode and cathode powders, which exhibit moderately high volume changes (e.g., 8-160 vol. %) during the first cycle, moderate volume changes (e.g., 4-50 vol. %) during the subsequent charge-discharge cycles, an average size in the range from around 0.2 to around 20 microns and relatively low density (e.g., 0.5-3.8 g/cc), are relatively new and their formation into electrodes using conventional binders, conductive additives, and mixing protocols may result in relatively poor performance characteristics and limited cycle stability, particularly if electrode capacity loading is moderate (e.g., 2-4 mAh/cm²) and even more so if it is high (e.g., 4-10 mAh/cm²). Larger volume changes (particularly during the initial cycles) may lead to inferior performance.

In an embodiment of the present disclosure, binder and conductive additives that work well for intercalation-type anode and cathode electrodes (of various particle size) as well as binders and conductive additives that work well for nano-sized (e.g., in the range from 1 nm to 200 nm) conversion-type anode and cathode electrodes or alloying-type anodes may perform poorly for high-capacity (nano)composite anode and cathode powders, which exhibit moderately high volume changes (e.g., 8-160 vol. %) during the first cycle, moderate volume changes (e.g., 4-50 vol. %) during the subsequent charge-discharge cycles and an average size in the range from around 0.2 to around 40 microns. For example, the larger size of such composites and the larger volume changes in such composites may lead to poorer performance characteristics when used in combination with certain binders (e.g., those conventionally used with nanosized conversion-type anode and cathode electrodes or alloying-type anodes).

Embodiments of the present disclosure are directed to reducing one or more of the above-discussed challenges of various types of nanocomposite electrode materials (for example, conversion-type and alloying-type materials). For example, various embodiments of the present disclosure may be implemented with respect to nanocomposite electrode material that experience certain volume changes during cycling (e.g., moderately high volume changes (e.g., 8-160 vol. %) during the first cycle and moderate volume changes (e.g., 4-50 vol. %) during the subsequent charge-discharge cycles) and an average size in the range from around 0.2 to around 20 microns for a broad range of batteries. Further, various embodiments of the present disclosure are further directed to formulating more stable electrodes in moderate (e.g., 2-4 mAh/cm²) and high capacity loadings (e.g., 4-10 mAh/cm²).

In at least one embodiment of the present disclosure, electrodes based on high capacity nanocomposite powders (e.g., comprising conversion-type or alloying-type active materials) that experience certain volume changes during cycling (moderately high volume changes (e.g., an increase by 8-160 vol. % or a reduction by 8-70 vol. %) during the first cycle and moderate volume changes (e.g., 4-50 vol. %) during the subsequent charge-discharge cycles) and an average size in the range from around 0.2 to around 20 micron (such as Si-based nanocomposite anode powders, among many others) may be paired with specific types of binders to achieve improved performance (e.g., particularly for electrodes with high capacity loadings).

For example, (i) continuous volume changes in high capacity nanocomposite particles during cycling in combination with (ii) electrolyte decomposition on the electrically conductive electrode surface at electrode operating potentials (e.g., mostly electrochemical electrolyte reduction in case of Si-based anodes) may lead to a continuous (even if relatively slow) growth of a solid electrolyte interphase (SEI) layer on the surface of the nanocomposite particles. In an example, if binders are used that swell substantially (e.g., by around 5-100 vol. % or reduce their modulus by over around 15-20%) in electrolytes (e.g., PVDF binders and the like), the interface between the nanocomposite particles and conductive carbon additives becomes filled with an SEI (electrolyte decomposition products) even if the binder coats and separates this interface from direct access of electrolyte. This is because electrolyte slowly permeates/penetrates through such “swellable” binders. The SEI growth at the composite electrode particles/conductive additive(s) interface leads to a gradual increase in the separation distance between the surface of the composite electrode particle and the attached conductive additive particle(s). A higher degree of swelling of the binders in electrolyte (stronger reduction in modulus) may lead to faster separation. This increase in separation distance may undesirably increase the composite electrode particle/conductive additive particle(s) contact resistance. Also, at some point the separation may reach a critical value that corresponds to the situation when a conductive additive particle(s) and composite electrode particle become effectively electrically separated (e.g., when the separation distance exceeds substantially a distance that may provide at least a moderate (e.g., greater than 0.1%) probability for “quantum tunneling” of electrons between the separated particles). A similar phenomenon may occur at the composite electrode particle/another composite electrode particle interfaces as well as the composite particle/current collector interfaces in the electrode. Once an electrode particle becomes electrically separated from other particles and the current collector of the electrode, it effectively stops being able to accept or donate electrons and thus cannot participate in electrochemical reactions (e.g., which are required for charge storage in a battery). As such, the electrode capacity becomes reduced by the capacity of this separated particle. The gradual electrical (or electrochemical) separation of the various active composite electrode particles within the electrode may lead to undesirable irreversible losses of electrode (and thus battery) capacity and eventual cell “end of life”. Higher binder swelling in electrolytes may lead to faster cell degradation and shorter cycle stability. Because higher temperature may increase SEI growth rate and electrolyte diffusion through the binders, stable cell operation at above around 40-50° C. (e.g., required for certain commercial cells) becomes particularly challenging to achieve. In contrast, some conventional (intercalation-type) electrode materials exhibit a stable SEI and thus could be used with a broad range of binders, including those that exhibit substantial swelling in battery electrolytes.

Swelling of binders in electrolytes depends on both the binder and electrolyte compositions. Furthermore, such swelling (and the resulting performance reduction) in certain applications may correlate with the reduction in elastic modulus upon exposure of binders to electrolytes. In this sense, the smaller the reduction in modulus, the more stable the binder-linked (protected) composite active particles/conductive additives interface becomes. In an example, a reduction in binder modulus by over 15-20% may result in a noticeable reduction in performance. Generally, the greater the reducing in binder modulus, the greater the reduction in performance. For example, a reduction in the binder modulus by two times (2×) may result in a first performance reduction, whereas a reduction in modulus by five or more times (e.g. 5×-500×) may result in a second performance reduction that is greater than the first performance reduction. Such “swellable in electrolyte” binders may exhibit either higher or lower maximum elongations (maximum strain) when exposed to electrolyte (e.g., reduction of maximum elongation may be undesirable). Exposure of electrodes with such binders to electrolyte may also weaken the interfaces between these binders and (nano)composite electrode particles, conductive additives and current collectors, which may be undesirable.

On the other hand, in certain applications, “swellable in electrolytes” binders may undergo substantial (5-200 vol. %) expansion (either in a dry state or when exposed to electrolyte) before failure (e.g. in a tensile test), and certain electrodes may exhibit a moderate (but substantial) change in volume during cycling.

As a compromise, in an embodiment, the use of binders that are slightly (e.g., 2-25 vol. %) swellable in electrolytes (e.g., polyvinyl alcohol (PVA)) may offer reasonable performance. For example, such binders may be used in combination with more effective conductive additives, such as carbon nanofibers and carbon nanotubes. In a further example, such binders may be used if the size of the high capacity particles is below a threshold (e.g., <6 micron). In a further example, such binders may be used if the amount of carbon additives is somewhat moderate or high (e.g., 0.3-15 wt. %) and if the capacity loading is moderate or moderate-high (e.g., 2-6 mAh/cm²).

However, binders that exhibit no or small (e.g., 0.001-2 vol. %) swelling upon exposure to electrolytes (such as various salts of Carboxymethyl cellulose (CMC) including, but not limited to Na-CMC, Li-CMC, K-CMC, etc., poliacrylic acid (PAA) and their various salts (Na-PAA, Li-PAA, K-PAA, etc.), various acrylic binders, various alginates (alginic acid and various salts of alginic acids) and other water-dissolvable binders in case of Li-ion batteries based on organic electrolytes) may be too brittle (even when exposed to electrolyte) for use in a cell with certain conversion-type or alloying-type particles. Furthermore, such binders may also be more rigid. As a result, such binders may not be able to accommodate (nanocomposite) particle volume change-induced stresses well and, as a result, may induce stress concentration at the particle/binder interfaces, which may become week points within the electrodes and lead to rapid electrode degradation during cycling (e.g., when particles get separated from the binder-carbon additive mix during cycling).

In embodiments of the present disclosure, when conversion-type or alloying-type particles exhibit small characteristic dimensions (e.g., below about 200 nm), the brittle nature of such binders does not induce a significant negative effect because the micro-cracks formed in such binders during cycling do not induce electrical separation between the very small active particles as these binders effectively form micro and nanoporous structures, which may be resistant to propagation of small cracks at the particle/binder interfaces. In contrast, when such binders are used with larger volume-changing particles (e.g., from 200 nm to around 40 micron), the brittle nature of the binders may lead to the mechanical failure of the electrode particle/conductive additive-binder interface (or mechanical failures of other portions of the binder that lead to capacity losses). This negative effect may become particularly pronounced when the mass fraction of conductive additives in an electrode is small (e.g., below around 2-5 wt. %) or when the volume changing electrode particles are bigger (e.g., from around 1-2 micron to around 40 micron). Moreover, this negative effect may also become particularly pronounced when the casted (on current collector foils) electrode capacity loading becomes moderate (2-4 mAh/cm²) and even more particularly pronounced when the casted (on current collector foils) electrode capacity becomes high (e.g., 4-10 mAh/cm²).

Larger particles, on the other hand, exhibit smaller specific surface area in contact with electrolyte and thus offer a lower rate of undesirable side reactions (e.g., smaller volume fraction of the SEI or other types of surface layers, less electrolyte decomposition, less dissolution of electrode materials, etc.). In addition, larger particles are easier to handle and process into electrodes. Finally, larger particles may require less binder and conductive additives for sufficiently stable performance, which may increase gravimetric electrode capacitance, rate performance and, in some cases, cell stability. Therefore, the use of larger particles may provide certain advantages over smaller particles, although larger particles may not perform well with some of the brittle (in electrolyte) binders, as noted above. Similarly, a smaller fraction of conductive additives in an electrode may be used because conductive additives occupy space (and thus reduce volumetric and gravimetric capacity of electrodes) and may induce undesirable side reactions (e.g., SEI formation, electrolyte decomposition, etc.) on their surface. Therefore, the use of small (e.g., below a conductive additive level such as 5 wt. %, 2 wt. %, or 1 wt. %) amounts of conductive additives may be desired for cell operation, although electrodes with a smaller fraction of conductive additives may not perform well with some of the brittle (in electrolyte) binders in combination with high-capacity volume-changing composite electrode particles, especially for electrodes with high capacity loadings.

At least one embodiment of the present disclosure may thereby be directed to electrode binders that exhibit small (e.g., 0.001-3.0 vol. %) swelling in selected battery electrolytes and are additionally sufficiently soft to allow moderate volume changes in the electrodes during cycling without inducing mechanical failure.

Electrode slurries with binders dissolved in organic solvents (e.g., N-methyl-2-pyrrolidinone (NMP) or toluene or other organic solvents) may be suitable for electrode preparation. However, fabrication and utilization of water-based electrode slurries (that comprise active particles, conductive additives, other functional additives and binders) may offer cost and ecological advantages. Therefore, binders that may be dissolved in water or dispersed in water (e.g., solvent-less binders) may be used in battery (e.g., Li-ion battery) electrodes. In some examples of water-soluble polymers with a variable degree of hydrolysis, a relatively low (e.g., below 20%) degree of hydrolysis may be avoided for use in aqueous slurries. In some examples of water-soluble polymers with variable degree of hydrolysis, high (e.g., above an upper hydrolysis threshold such as 98%) or low (e.g., below a lower hydrolysis threshold such as 20%) degrees of hydrolysis for use in aqueous slurries may be avoided. In some examples, a targeted degree of hydrolysis may range from about 50% to about 90% (in some examples, a narrower range of 65-85% may be targeted). In an example, the targeted hydrolysis range may be configure such that, outside of the targeted hydrolysis range, the slurries may not be sufficiently uniform to warrant good performance and uniform mixing of the components (conductive additives, binder(s), active (nano)composite powders, etc.) Water soluble polymer binders with a high degree of hydrolysis (e.g., from about 90% to about 100%; in some designs—from about 92% to about 100%; in some designs—from about 94% to about 100%; in some designs—from about 96% to about 100%) may be used to reduce or avoid “foaming” during the aqueous slurry preparation. For example, such foam-reducing binders may be used in applications where the use of de-foaming agents or co-solvents with low surface tension is undesirable (e.g., due to their higher cost, flammability, undesirable residues remaining in the electrode, unfavorable interactions with various electrode components, etc.). In some designs, small amounts (e.g., 0.1-20%) of alcohols (e.g. ethanol, methanol, isopropanol and others) as co-solvents may be used in aqueous slurries to reduce or prevent formation of bubbles during mixing and/or to achieve more uniform slurries.

The chemical properties of solvents (e.g., carbonates) used in the Li-ion batteries may define suitable chemical structures of the possible suitable soft binders that exhibit no-to-small swelling (e.g., 0-3 vol. %). In an example, binder having a Hansen solubility parameter that is outside the range of electrolyte solvents (e.g., carbonates) solubility parameter range (e.g., 22-29) may be selected.

Examples of suitable soft binders that exhibit no-to-small swelling (e.g., 0-3 vol. %) for use in Li-ion (and other) batteries include, but are not limited to, fully or partially fluorinated polymers, which may have low glass transition temperatures (Tg), which implies a rubbery (soft) behavior at ambient conditions. At the same time, the fluorinated nature of the polymer backbone may provide a low swellability in electrolytes used in Li-ion batteries (e.g., low swelling in carbonates used as solvents in certain Li-ion batteries).

Other examples of suitable soft binders that exhibit no-to-small swelling (e.g., 0-3 vol. %) for use in Li-ion (and other) batteries include, but are not limited to, polytetrafluoro ethylene (PTFE), polyperfluoroprophylene, higher polyperfluoroalkenes and their copolymers in different ratios. It is noted, however, that a semi-crystalline nature of these polymers make them either insoluble or soluble only in fluorinated solvents. In an example, one practical way to utilize these polymers as binders is in the form of water dispersions of small particles (latexes). “Dyneon” fluoropolymer dispersions (3M) is an example of a commercially available polymer. Other suitable fluorinated polymers include, but are not limited to, perfluoroalkoxy (PFA), fluorinated ethylene propylene (FEP), TEFLON amorphous fluoroplastics (AF) polymers. In a further example, some fluorinated polymers can be used as water dispersions (PFA, FEP), while others can be used when dissolved in fluorinated solvent(s) or in the form of water based latex (TEFLON AF).

Other examples of suitable soft binders that exhibit no-to-small swelling (e.g., 0-3 vol. %) for use in Li-ion (and other) batteries include, but are not limited to, polyacrylates or polymethacrylates, which may be made from fluorinated alcohols. Glass transition temperatures (Tg) of these polymers may decrease with an increase of the alcohol chain length in their structure. Polymethacrylates may have a higher Tg when compared to corresponding polyacrylates. In an embodiment, by tuning alcohol chain length in the polymer, a desired Tg (which defines softness at a given temperature) of the corresponding polymer can be targeted.

In a further embodiment, copolymerization of the different monomers adds another lever to tune the final properties of the final polymeric binder. These polymers (copolymers) may be prepared by conventional solution polymerization methods or may be made in the form of water based latexes. Different preparation methods may be used for different applications. Binders made in latex form may be additionally copolymerized with bi-functional monomers in order to fine-tune mechanical and adhesive properties of such binders.

In some examples, suitable binders may additionally exhibit sufficiently strong adhesion to (nano)composite electrode particles (e.g., particularly when exposed to electrolyte). To enhance binder/(nano)composite electrode material particle interface strength (e.g., in order to withstand electrode integrity and electrical inter-connectivity of the (nano)composite particles in the electrode during cycling in a cell), certain functional groups can be added to the binder (e.g., via copolymerization or other means), certain functional groups can be added to the electrode particles, certain functional groups can be added to the conductive additives, or a combination thereof.

Other examples of suitable soft binders that exhibit no-to-small swelling (e.g., 0-3 vol. %) for Li-ion (and other) batteries include, but are not limited to, silicon-based polymers, which have low Tg (e.g., below room temperature such asbelow (minus) −20° C. or below −30° C. in order to increase the useful temperature range within which these binders remain soft). These polymer binders may be prepared by various methods used to make silicone based polymers. To decrease (e.g., diminish) binder swell in the Li-ion electrolyte solvents, fluorinated substituents (perfluoro or partially fluorinated) may be introduced into their structure. In an example polymerization methods to prepare these binders may include, but are not limited to: alkoxysilane condersation, hydrosililation reaction, radical polymerization of vinylsilanes, among others. These polymerizations may be carried out either in solution, water-based emulsion or solventless. The particular type of binder preparation employed may depend on the specific application.

In a further embodiment, a condensation polymerization procedure may be used to make step-growth fluorinated binders. Examples include, but are not limited to reactions between dialed and diols, diacids and diamines, diisocyanates with diols, diisocyanetes with diamines etc. To obtain soft, largely “non-swellable” binders, one or both reagents may contain fluorinated fragments: i.e., per fluorinated acids, a,a-H,H,w,w-H,H-perlfuorodiols, dihydroxy terminated perfluoroethers (Fomblin, 3M) are examples of the fluorinated building blocks. Additionally, combinations of various buildings blocks may be used to target desired binder properties. In some cases, the binder may be prepared by solution polymerization (diacid+diol) or polymerization may be done without a solvent, or binder formation may be done during mixing binder ingredients with active electrode materials, deposition on the current collector and polymerizing preformed electrode by exposure to elevated temperatures.

In one or more embodiments, (e.g., aqueous) binder suspension may include surfactant in order to achieve uniform binder distribution in a slurry.

In one or more embodiments, more than one binder may be utilized. For example, one binder may exhibit very low swelling in electrolyte (even if possibly being relatively brittle) and another binder may exhibit some or substantial swelling and, at the same time, exhibit significant plasticity (larger deformation prior to failure) and/or be more easily dissolvable in a slurry solvent (e.g., water). In an example, the “less swelling” (and possibly more brittle) binder may be located at the interface between the volume changing composite electrode particles and conductive additives in order to provide long-term stability of the electrode particle/conductive additive interface, while the softer and possibly more “swellable” binder allows for accommodation of the volume changes in the electrode without mechanical failure. This more swellable binder may be located in between the electrode particles. This distribution of the two binders may be achieved by tuning the chemistry of the surface moieties or/and surface charge on the surface of the particles. In one or more embodiments, the binder located at the particle/binder interphase may be soft and deformable. In one or more embodiments, the two binders may exhibit substantially different (e.g., by over 30%) solubility in a slurry solvent (or solvent mixture). If one of the binders exhibit lower solubility, the drying of a casted slurry may induce adsorption of this binder onto the surface of the electrode particles while the other binder remains in a solution. In an example, the eventual drying of the electrode may thus induce a distribution of the two binders—one binder (e.g., the one that provides stronger adhesion to the active electrode particles) being located at the surface of the volume-changing (nano)composite electrode particles, while the other binder (e.g., softer and more deformable) is located in between the electrode particles to accommodate the volume changes without inducing undesirable cracks and defects within the electrode.

In one or more embodiments, a second binder may be infiltrated after an electrode is dried with a first binder. In this case, a first binder (or a combination of binders) may be localized at the surface of the electrode particles in order to protect the electrode particle/conductive additive interface from physical separation during cycling. Such infiltration may be conducted before or after calendaring (if calendaring is employed to enhance the volumetric density and volumetric capacity of the electrodes).

In one or more embodiments one binder may be first mixed with electrode particles and another binder be first mixed with conductive additives prior to mixing these two slurries together to form a final slurry for eventual electrode coating. For example, such a strategy may allow adsorption of one (e.g., less “swellable” or more brittle) binder to the electrode particles and another (e.g., softer and more deformable) binder to the conductive additives and thus achieve a desired distribution of the binders within the electrode. The two binders may chemically react at elevated temperatures (e.g., after or during the electrode formation) and form desired properties at the binder1-binder2 interface (interphase).

In one or more embodiments, the properties of the relatively “swellable” (but soft in electrolyte) binder(s) may be changed at the proximity of the interface between the volume changing composite electrode particles and conductive additives. For example, the binder properties (e.g., by cross-linking or by involving other chemical reactions with the surface moieties of the electrode particles or some of the conductive additives or both) may be locally modified in order to reduce local swelling and achieve a locally higher elastic modulus at the interface between the volume changing composite electrode particles and conductive additives. In this case, the “bulk” of the binder may still allow the electrode to withstand volume changes during long-term cycling, while at least a portion of the interface between the conductive additives and active electrode particles will be largely protected from SEI formation and electrical separation.

In one or more embodiments, a binder in the form of a block-copolymer may be used. For example, one block of the binder may have a strong affinity to the electrode particle surface and be non-swellable (exhibit low swelling) in the electrolyte, thus preventing or decreasing SEI formation at least at a portion of the electrode particle/conductive additive interface that otherwise may lead to their gradual electrical separation. A second block of the binder may be swellable in the electrolyte solvent and be sufficiently soft (in electrolyte) in order to tune one or more mechanical properties of the binder to withstand moderate volume changes during cycling without failure. Block-copolymer may be made by any suitable “living” type of polymerization methods, including but not limited to anionic, atomic transfer radical polymerization (ATRP), ring-opening metathesis polymerization (ROMP), reversible addition-fragmentation chain transfer (RAFT), and other suitable means. In some applications, the particular type of the suitable polymerization technique may be defined by the chemical nature of the binder blocks.

In one or more embodiments, the volume-changing (nano)composite electrodes may utilize polymer binders that exhibit a relatively low glass transition temperature to accommodate the mechanical stresses during calendaring (densification) and electrochemical cycling. In addition to the previously discussed polymer binders, some polymeric organosilicon compounds, such as polydimethylsiloxane (PDMS) and others, may be used in one or more embodimentsof the present disclosure. In one example, crystalline PDMS exhibits a very low glass transition temperature of minus (−) 125° C. and a melting point of minus (−) 40° C., making it a soft and easily deformable polymer binder material that may be calendared at low temperatures (e.g., at room temperature). Many organosilicon polymers (PDMS included) may be cross-linked, which may further improve electrode performance. In an example, such cross-linking may be performed during electrode drying. In one or more embodiments, cross-linking may improve their mechanical stability, increase elastic modulus (at both low and high temperatures), affect glass transition temperature and other properties, thus allowing multiple avenues for the improvement of electrode performance in cells. In an example, PDMS and some other organosilicons with an apolar (non-polar) structure may be used, which may decrease their swelling in electrolyte solvent, which may in turn improve electrode stability, reduce undesirable side-reactions (such as SEI formation, among others) and improve volumetric capacity (e.g., because binder swelling in electrolyte may induce overall electrode expansion upon electrolyte filling). In a further example, formation of block copolymers of PDMS (or other with similar properties) with water soluble blocks may be used to provide water solubility on one side and adsorption to the surface of the (nano)composite electrode materials. A similar approach may also be utilized for other suitable polymer binders.

In one or more embodiments, polyacrylates and polymethacrylates (and their derivatives and co-polymers) may be used as binders for the above-noted (nano)composite electrode materials. Such polymers are available with various side chain lengths and functionalities and may be tuned to achieve a desired solubility, mechanical properties, adhesion and stability.

In one or more embodiments, a solution of two or more solvents may be used in the slurry preparation. In one illustrative example, one of the co-solvents may exhibit substantially lower surface tension (e.g., 30% or more) than another co-solvent. In one or more embodiments, the slurry solvent mix may be configured to exhibit a lower surface tension during slurry mixing (e.g., in order to achieve more uniform distribution of binder(s), active (nano)composite particles, conductive additive(s) or other functional additives), while exhibiting higher surface tension during the final electrode drying stages (e.g., in order to reduce or prevent formation of cracks within the electrode). Thus, if the co-solvent with the lower surface tension exhibits lower vaporization point, electrode drying may remove the co-solvent from the casted slurry during the drying process, effectively and continuously increasing the surface tension of the remaining solvent mix, which may help to improve electrode quality. In another illustrative example, two polymer binders may be dissolved in a solvent mix, with one of the binders exhibiting substantially lower solubility (e.g., 30% or more) in one of the co-solvents. In this case, the continuous evaporation of this co-solvent from the casted slurry during electrode drying may induce precipitation of one of the binders at the electrode particles (e.g., because the second binder may still exhibit high solubility in the remaining co-solvent). Eventual completion of the electrode drying thus may result in a first of the polymer binders being located at the interface with the electrode particles, with a second of the polymer binders being located between the particles (e.g., in some cases, the second polymer may be on top of the first polymer binder). In an example, as discussed above, one of the polymer binders may provide stronger adhesion to the active (nano)composite particles, while the other polymer binder provides flexibility to the electrode needed for accommodation of the volume changes within active (nano)composite electrode particles during cycling. In one or more embodiments when two or more binders are used in the slurry, the first evaporated co-solvent may also exhibit higher surface tension.

In one or more embodiments when two or more solvents are used in the slurry preparation, both co-solvents may exhibit either no flash points or a relatively high flash point (e.g., above a temperature flash point threshold such as +25 C, +50 C, +60 C). In one or more embodiments when two or more solvents are used in the slurry preparation, one of the solvents to be water. In one or more embodiments when one of the co-solvents is water (e.g., surface tension of around 70 dyn/cm against air at room temperature), another co-solvent with both a lower boiling point (bp) and lower surface tension is sed. In one or more embodiments when one of the co-solvents is water (e.g., when the electrode benefits from a particular distribution of polymer binders within the electrode), another co-solvent is used which exhibits a higher boiling point (bp) even if its surface tension is still lower than that of water. In an example, this high boiling co-solvent may exhibit a high flash point. In a further example, this high boiling point co-solvent may be limited in toxicity (e.g., similar or less toxic to humans and animals than N-methyl-2-pyrrolidinone). In one or more embodiments when one of the co-solvents is water, another co-solvent may exhibit relatively high solubility in water (e.g., greater than 10%, greater than 20%, greater than 30%, etc.) or be completely miscible with water. Examples of suitable co-solvents may include, but are not limited to diethylene glycol (boiling point 246° C.; flash point 124° C.; 100% solubility—miscible with water); diglyme (diethylene glycol dimethyl ether) (boiling point 162° C.; flash point 67° C.; miscible with water); dimethyl sulfoxide (DMSO) (boiling point 189° C.; flash point 95° C.; miscible with water); ethylene glycol (boiling point 195° C.; flash point 111° C.; miscible with water); hexamethylphosphoramide (HMPA) (boiling point 232.5° C.; flash point 105° C.; miscible with water); glycerin (boiling point 290° C.; flash point 160° C.; soluble in water); N-methyl-2-pyrrolidinone (NMP) (boiling point 202° C.; flash point 91° C.); N-ethyl-pyrrolidone (NEP) (boiling point 212° C.; flash point 90° C.), to name a few.

In one or more embodiments when water is used as a slurry solvent (or a slurry co-solvent) for at least one of the mixing operations, a neutral pH need not be used. In one example, pH adjustment may be induce a positive or a negative charge on the surface of active (nano)composite electrode particles or other particles in a slurry in order to achieve more uniform dispersion. In another example, pH adjustment may be used in order to induce controlled adsorption of at least one of the binder component(s) on the surface of active (nano)composite electrode particles. Depending on the composition and surface chemistry of the particles in a slurry as well as the binder composition, targeted pH values may range from around 3 to around 12. In an example, more extreme pH values (e.g., less than 3 or greater than 12; depending on the composition of the slurry) may induce undesirable damage to the particles or the binder or another co-solvent (if present).

In one or more embodiments, one dimensional (1D) conductive additives (such as single-walled carbon nanotubes, double-walled carbon nanotubes, multiwall carbon nanotubes, carbon (nano)fibers, compatible metal nanofibers, nanotubes and nanowires (e.g., copper, nickel, titanium, or iron nanowires/nanofibers for low-voltage Li-ion battery anodes such as Si-based, Sn-based, C-based and others; aluminum, iron, or nickel nanowires/nanofibers for high voltage Li-ion battery anodes, such as lithium titanate, P-based and others or the Li-ion battery cathodes, etc.)) may be used in electrodes comprising the discussed high-capacity volume-changing (nano)composite materials. In an example, if metal nanowires or nanofibers are used as conductive additives, some of the conductive additives (e.g., Cu, Ni, Ti, or others) may be coated with a thin (e.g., 0.2-10 nm) layer of conductive carbon or polymer (with optional functional groups on its surface) or other functional surface layer to (i) reduce or prevent their corrosion during the slurry preparation or handling, or (ii) improve dispersion in a slurry, or (iii) improve their adhesion in an electrode, or any combination thereof.

In one or more embodiments, conductive additives (for example, 1D additives) may be added in different operations during the electrode slurry mixing. In one illustrative example, (i) some conductive additives and active (nano)composite materials are mixed in a solvent in one operation (e.g., a first operation) and (ii) a binder (or binder solution or binder suspension) and additional conductive additives (or suspension of conductive additives) are added in another operation (e.g., a second operation that occurs after the first operation). In one or more embodiments, a substantially higher viscosity (e.g., by 2-10,000 times) of the mix is used in the first operation (or at least one of the initial operations of the electrode slurry mixing) than in the subsequent (or the final) slurry mix. In an example, the observed improved performance in this case may be achieved due to the achievement of a higher effective shear rate needed to break up any agglomerates and more uniformly distribute slurry ingredients.

In one or more embodiments, a substantially higher fraction (e.g., by 1.2-100 times) of solids in the first operation (or at least one of the initial operation) of the electrode slurry mixing may be present relative to the subsequent (or the final) slurry mix. Such procedures may lead to improved performance, which may be related to better slurry dispersion.

In one or more embodiments when more than one binder is used, binders (or binder suspension(s) or solution(s)) may be added in different operations during the electrode slurry mixing. In one illustrative example, (i) some conductive additives and active (nano)composite materials are mixed in a solvent in one operation (e.g., a first operation), (ii) a first binder (or first binder solution or first binder suspension) and possibly additional conductive additives (or suspension of conductive additives) are added in another operation (e.g., a second operation that occurs after the first operation), and (iii) a second binder (or second binder solution or second binder suspension) and possibly additional conductive additives (or suspension of conductive additives) is added in another operation (e.g., a third operation that occurs after the second operation).

In one or more embodiments when gradual (or step-wise) binder addition is utilized, the binder(s) may be selected so as not to adsorb onto electrode particles or conductive additives (from a binder solution or slurry) during slurry mixing to the level when they link particles together and form aggregates. At the same time, in one or more embodiments (for example, when more than one binder is used and when one binder may be located at the surface of electrode particles or when one binder may help one to achieve more uniform dispersion of particles in a solution, acting similar to a surfactant), at least partial (e.g., 20-100%) surface adsorption of one binder may be achieved during the slurry mixing. In at least one embodiment, the slurry composition, surface chemistry of the electrode particles and conductive additives, slurry solvent and mixing protocols are arranged in such a way as to reduce or avoid formation of agglomerates during the slurry mixing.

In one or more embodiments, binder(s), conductive additive(s) and slurry solvent may be pre-mixed prior to adding this mix to active particles (or prior to adding active particles to this mix). This may simplify the mixing protocol when only one ingredient (i.e., this premix) is used for mixing with active electrode particles.

In one or more embodiments, different types of conductive additives may be used in different operations during the slurry mixing (e.g., in aqueous slurries). In one or more embodiments, conductive additives (for example, 1D additives) are mixed in a solution before adding the binder (or binder solution or suspension) or the active (nano)composite materials (e.g., in aqueous slurries). In one or more embodiments, surfactant(s) are used during the conductive additives (for example, 1D additives) mixing or dispersing in a solution. In one or more embodiments, the surface of conductive additives is functionalized with functional groups or small molecules or polymers to improve (or to better control) their dispersion (distribution) in a slurry (e.g., during the electrode slurry mixing) and the final (casted) electrode.

In one or more embodiments, the binder (or binder solution or binder suspension) is added to the slurry mix during the slurry mixing after at least some of the conductive additives are mixed with the active (nano)composite materials. In one illustrative example, (i) some conductive additives and active (nano)composite materials are mixed in a solvent in a first operation, and (ii) binder (or binder solution or binder suspension) is added in a second operation (e.g., after the first operation). In one or more embodiments, binder (or binder solution or suspension) may be added in different operations during the slurry mixing. In one or more embodiments different types of binders may be added in the different operations during the slurry mixing.

In one or more embodiments, ultrasound (sonication) in at least one of the slurry mixing operations may be used to improve dispersion of the components (e.g., conductive additives or the active powders, etc.). In one or more embodiments, mechanical shear mixing may be combined with sonication (e.g., concurrently) to prepare a slurry during the slurry mixing. In one or more embodiments, the shear mixing may be utilized at the power density in the range from around 0.01 kW/L-slurry to around 30 kW/L-slurry. In one or more embodiments, the sonication may be utilized at the power density in the range from around 0.05 kW/L-slurry to around 50 kW/L-slurry. In an example, lower power densities may be insufficient to provide sufficient electrochemical performance (e.g., possibly due to insufficientdispersion of components), while higher power densities may induce undesirable damage to conductive additives, active particles and binders. In one or more embodiments, ultrasonic flow-through systems may be utilized.

In one or more embodiments, shear mixing and sonication may be conducted in a temperature-controlled environment. Since mixing procedures add energy to a slurry, cooling may be applied at least at some portion of the mixing procedures. In one or more embodiments, either mixing or sonication or both may be applied at below or above the ambient temperature (room temperature). Depending on the slurry and solvent composition and solvent fraction, a suitable temperature range may be from around minus (−) 30° C. to around plus (+) 80° C. In some embodiments, depending on the polymer binder composition, both lower or higher temperatures may lead to increasing viscosity. In an example, viscosity may be a parameter that impacts the effectiveness of the slurry mixing.

In one or more embodiments (e.g., in cases when more than one binder is utilized in electrode construction), one of the binders (e.g., the second binder) is infiltrated into the electrode after electrode drying. The calendaring (electrode densification) may be conducted before or after the introduction (e.g., infiltration) of this additional binder.

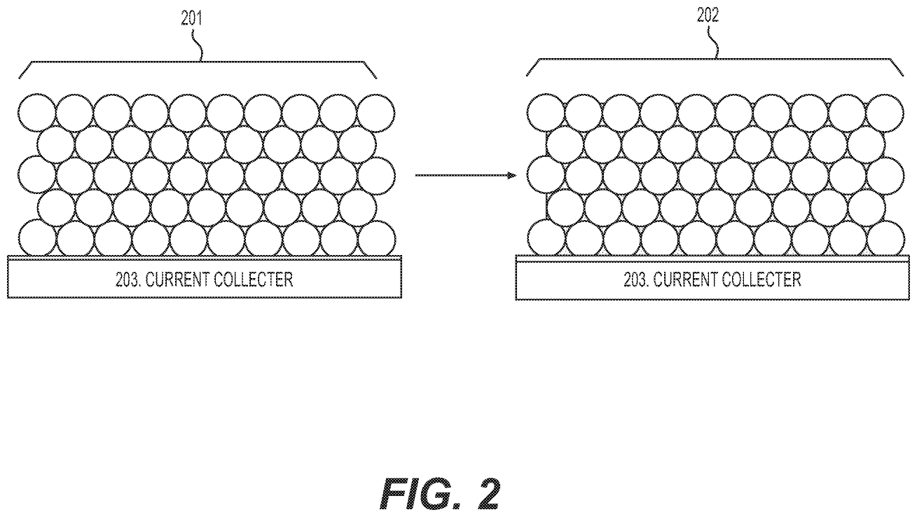

FIG. 2 illustrates a schematic example of an electrode formation process (e.g., one side of the electrode 201 is shown for simplicity), where a second binder #2 is infiltrated into an electrode the pre-formed using a first binder #1. Electrode 202 depicts the electrode 201 after the infiltration. Also shown coupled to electrode 201/202 is a current collector 203.

In one or more embodiments, electrode-level swelling is reduced (e.g., minimized) by providing controlled spacing between the individual volume-changing particles. In one or more embodiments, such spacing may be relatively uniform within the electrode. In an example, the spacing may be determined based on the properties of the particles (e.g., value of the volume changes in first and subsequent cycles) as well as the properties of the binder. In one or more embodiments, the value may range from around 0.1% to around 60% of the characteristics size (e.g., diameter) of the volume changing electrode particles. In some designs and (nano)composite electrode particle compositions, the value may range from about 5% to about 20% of the characteristics size (e.g., diameter) of the volume changing electrode particles. In some designs, the value may range from about 20% to about 100% of the changes (expansion) in the characteristics size (e.g., diameter) of the volume changing electrode particles during the first charge-discharge cycle or half cycle (e.g., during the lithiation). In one or more embodiments, such porosity (spacing) may be introduced by using sacrificial compounds, which are removed from the electrode (e.g., by dissolution) after electrode casting (and optional calendaring or densification). Sacrificial metal salts (e.g., NaCl, KCl, LiCl, MgCl₂, LiNO₃, NaNO₃, KNO₃, Mg(NO₃)₂, Na₂SO₄, K₂SO₄, Li₂SO₄, MgSO₄ and various other inorganic and organic salts), various organic molecules (e.g. various sugars and other molecules) and polymers are examples of suitable sacrificial spacing-inducing (spacing-producing) material. In one or more embodiments, these sacrificial materials may exhibit high solubility (e.g., greater than 2M in the case of salts) in water or in alcohol (e.g., ethanol, methanol, isopropanol, etc.), which may be used for their dissolution/removal from the electrode. In one or more embodiments, these sacrificial materials may exhibit affinity to the electrode particles so as to create more conformal shells around the particles during drying. In a further example, these sacrificial materials may have affinity to conductive additives so that the electrode particles remain electrically connected to each other after the sacrificial material is removed from the electrode.

In one or more embodiments, such additional electrode porosity and spacing between the individual particles may be introduced by reducing electrode shrinkage during drying. In some examples (e.g., when binder solutions are used), such shrinkage may be reduced (e.g., minimized) by exposing a not fully dried casted electrode to a non-solvent for a polymer binder. This may reduce the electrode shrinkage even until complete or near-complete drying is achieved. In one or more embodiments, freeze drying may also be utilized, although possibly at higher cost.

In one or more embodiments, the spacing between the individual volume-changing particles in the electrode may be introduced by using porous particles (e.g., porous or hollow polymer particles, which may be near-spherical in shape), which may at least partially accommodate the volume changes. In one or more embodiments, such porous particles may have the opposite surface charge to the charge of the active composite particles in order to achieve their uniform coating and reduce or prevent their agglomeration in the slurry. In one or more embodiments, other approaches may be utilized in order to achieve uniform coatings of active (nano)composite particles with porous (e.g., hollow) particle-spacers.

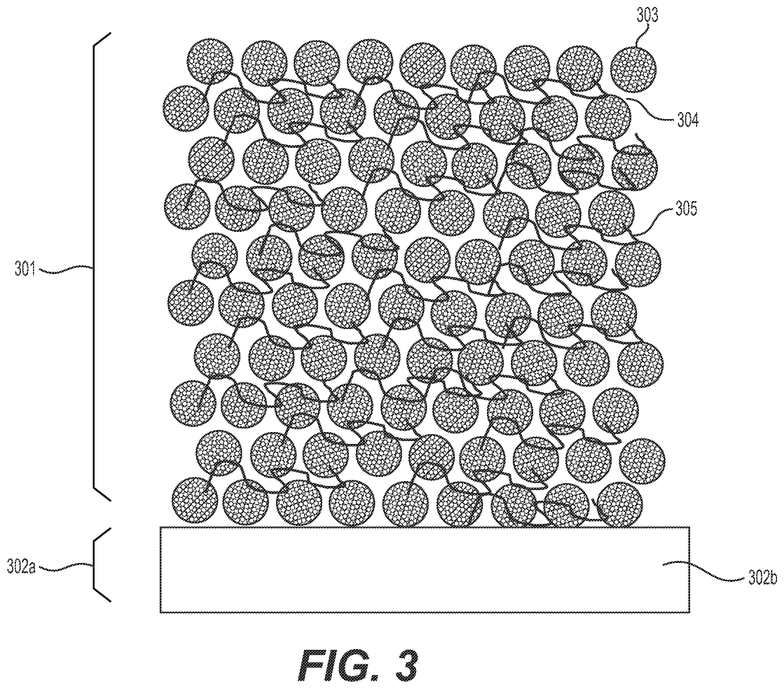

FIG. 3 illustrates a schematic example of the electrode (one side of the electrode 301), where (nano)composite particles 303 have spacing 304 between each other to accommodate volume expansion during lithiation in accordance with an embodiment of the present disclosure. Conductive additives 305 (e.g., carbon nanotubes or carbon fibers or nanowires or other suitable conductive additives) electrically connect individual particles to each other. Further shown in FIG. 3 is a current collector 302a and current collector foil 302b, which may be electrically connected to the (nano)composite particles 303.

In one or more embodiments, a conductive interlayer may be arranged between the electrode and current collector foils. In an example, the conductive interlayer may enhance rate performance of the electrode with volume-changing (nano)composite electrode particles, and may also enhance electrode stability. In a further example, the conductive interlayer may be used in association with electrodes comprising (nano)composite particles exhibiting larger volume changes. In a further example, the conductive interlayer may be used in association with electrodes produced at medium-to-high capacity loading (e.g., 3-10 mAh/cm²). In a further example, the conductive interlayer may be used in association with thin current collector foils (e.g., foils with an average thickness from around 4 pm to around 15 pm). The use of both higher capacity loadings and thinner foils may improve energy density of the cells. The volume changes in the electrode (e.g., at both the first cycle and subsequent cycling) may induce significant stresses within the current collector foils, which may eventually lead to their mechanical failure. Similarly, such volume changes may also lead to separation of at least portions of the electrodes from the current collector foils. Moreover, higher capacity loadings may induce larger stresses at both the electrode/foil interface and, in some cases, within the current collector foil and, thus, lead to mechanical failure(s). If such stresses exceed some critical value related to the electrode/foil adhesion strength, the electrode may delaminate from the current collector foil after a certain number of charge-discharge cycles. The use of a conductive interlayer may help to reduce stress concentration and improve electrode adhesion. Therefore, the conductive interlayer may reduce or prevent the delamination and improve cell cycle stability to acceptable values. In one or more embodiments, the strain and stresses within the electrode may effectively translate into the (cycling) strain and stresses within the current collector foils. In an example, thinner current collector foils may not exhibit sufficiently high strength, sufficiently high maximum strain or sufficiently good fatigue resistance and, thus, form cracks and fractures during cycling, leading to premature cell failure. The use of a conductive interlayer between the electrode and current collector foils may absorb some of the stresses, thereby reduce stresses within the current collector foil so as to reduce, prevent and/or delay foil failure. In some designs, this conductive interlayer (which may be called “a buffer layer”) may be deposited on the surface of the metal current collector prior to electrode slurry coatings. In some designs, this conductive interlayer (or buffer layer) may be deposited on the metal current collector (e.g., metal current collector foils) by tape casting (e.g., slurry casting) or by spraying or by another suitable technique.

In one or more embodiments, the above-noted conductive interlayer may comprise solid particles, a polymeric binder and pores. The polymer binder may be electrically conductive or electrically insulative. The mechanical properties of the polymer binder may be tailored to a particular electrode design. In an example, a suitable fraction of electrically conductive materials within the conductive interlayer may range from around 0.1 wt. % to around 100 wt. %. In a further example, the conductive interlayer may remain electrically conductive even when a small fraction of conductive materials is utilized (e.g., so that electrical percolation of conductive particles is achieved within the conductive interlayer). In a further example, solid particles in the conductive interlayer may exhibit a near-spherical or elliptical shape, irregular shape, be planar (e.g., two dimensional, 2D) or be elongated (e.g., one dimensional, 1D). In one embodiment, the average smallest dimension of the solid particles (diameter or thickness) may range from around 0.3 nm to around 5 microns (e.g., around 1 nm to around 300 nm). In the case of 1D and 2D solid particles, in an embodiment, the average largest dimension of the solid particles (e.g., average length of the (nano)fibers, (nano)wires, (nano)tubes, or average diameter of planar particles) may range from around 10 nm to around 5,000 μm (e.g., from around 500 nm to around 30 μm). For certain applications, planar or elongated (2D or 1D) particles with a larger length (e.g., above 5,000 μm) may be challenging to coat/deposit on a current collector foil.

In one or more embodiments, the use of mechanically strong 2D and 1D nanomaterials within this conductive interlayer improves its mechanical properties and thus may provide cell stability improvements. 1D materials may additionally provide simplicity for the conductive interlayer fabrication because 1D materials may be easier to disperse or intermix with other components of the conductive interlayer. In an example, a suitable fraction of such 1D nanomaterials in the conductive interlayer may depend on the particular electrode design, and may range from around 0 wt. % to around 100 wt. %. Suitable examples of 1D materials include, but are not limited to, single walled carbon nanotubes (SWCNTs), double-walled carbon nanotubes (DWCNTs), multi-walled carbon nanotubes (MWCNTs), carbon (nano)fibers, suitable (compatible with the electrode) metal (nano)wires, (nano)tubes and (nano)fibers (for example, copper, iron, nickel, or titanium or their alloys for Li ion battery anodes; aluminum or nickel for Li-ion battery cathodes), suitable (compatible with the electrode) ceramic nanowires or nanofibers (for example, nanowire or nanotube or nanofibers comprising aluminum oxide, zirconium oxide, magnesium oxide, and other oxides; titanium nitride, boron nitride, various other nitrides; various other suitable ceramic materials), suitable polymer or organic (nano)fibers, various structural composite and core-shell (nano)fibers, (nano)wires and nanotubes, etc. The 1D materials in the conductive interlayer may be conductive or may be insulative. In one embodiment, higher electrical conductivity in the 1D materials may facilitate higher power performance and better electrical connectivity between the electrode and the current collector foil. However, electrolyte may decompose on electrically conductive particles. Therefore, the ratio of electrically conductive and electrically insulative particles may be determined as a tradeoff between electrical performance and electrolyte decomposition. In one or more embodiments, electrically conductive particles may primarily serve to add electrical conductivity to the conductive interlayer. In other embodiments, the electrically conductive particles may serve to provide mechanical reinforcement and absorb some of the mechanical loading of the electrode on the current collector foil. Insulative particles may be primarily added to the conductive interlayer to enhance mechanical stability of the foil-interlayer-electrode (e.g., for a one-sided electrode) or the electrode-interlayer-foil-interlayer-electrode (e.g., for a two-sided electrode) system during cycling. In one or more embodiments, a combination of different solid particles within the conductive interlayer may be used. In one or more embodiments, at least one type of the solid particles in the conductive interlayer may exhibit a 1D shape.

In some designs, the binder in the conductive interlayer may be poly(vinyl alcohol), PVA. In some designs, the binder in the interlayer may comprise PVA.

In some designs, the binder in the interlayer may be a copolymer. In some designs, this copolymer binder may be water-soluble. In some designs, water-soluble copolymer in the interlayer may comprise at least one of the following components: vinyl (or butyl or methyl or propyl, etc.) acetate, vinyl (or butyl or methyl or propyl, etc.) acrylic, vinyl (or butyl or methyl or propyl, etc.) alcohol, vinyl (or butyl or methyl or propyl, etc.) acetate-acrylic, vinyl (or butyl or methyl or propyl, etc.) acrylate, styrene-acrylic, alginic acid, acrylic acid, vinyl (or butyl or methyl or propyl, etc.) siloxane (or other siloxanes), pyrrolidone, sterene, various sulfonates (e.g., styrene sulfonate, among others), various amines (incl. quaternary amines), various dicyandiamide resins, amide-amine, ethyleneimine, diallyldimethyl ammonium chloride. In some designs, copolymer binders may comprise poly(acrylamide) (that is, comprise acrylamide (—CH₂CHCONH₂—) subunits). In some designs, such poly(acrylamide)-comprising copolymer binders may be water soluble. In some designs, such poly(acrylamide)-comprising copolymer binders may also comprise acrylic acid, carboxylic acid, alginic acid or metal salt(s) thereof (e.g., Na, K, Ca, Mg, Li, Sr, Cs, Ba, La and other salts of such acids). Such and other additions may be utilized to tune the ionic character of the polymer, the solubility of the polymer, and/or interactions with both the solvents and active (electrode) particles (e.g., to achieve stability of a slurry, etc.).

In some designs, anion conducting heterogeneous polymers (such as alkoxysilane/acrylate or epoxy alkoxysilane, etc.), various anion conducting interpenetrating polymer networks, various anion conducting poly (ionic liquids) (cross-linked ionic liquids) or poly(acrylonitriles), various anion conducting polyquaterniums, various anion conducting comprising quaternary ammonium salts (e.g., benzyltrialkylammonium tetraalkylammonium, trimethyl ammonium, dimethyl ammonium, diallyldimethylammonium, etc.), various anion conducting copolymers comprising ammonium groups, various anion conducting copolymers comprising norbornene, various anion conducting copolymers comprising cycloalkenes (e.g., cyclooctene), methacrylates, butyl acrylate, vinyl benzyl or poly(phenylene), various anion conducting copolymers comprising organochlorine compounds (e.g., epichlorohydrin, etc.), various anion conducting copolymers comprising ethers, bicyclic amines (e.g., quinuclidine), various anion conducting poly (ionic liquids) (cross-linked ionic liquids), various anion conducting copolymers comprising other amines (e.g., diamines such as ethylene diamine, monoamines, etc.), various anion conducting copolymers comprising poly(ether imides), various polysaccharides (e.g., chitosan, etc.), xylylene, guanidine, pyrodinium, among other units, may be used as copolymer binders (or components of the polymer/copolymer binder mixture) in the conductive interlayer in various embodiments of the present disclosure. In some designs, the copolymer binder may be cationic and highly charged.

In some designs, various cation conducting polymers (including interpenetrating polymer networks) and cross-linked ionic liquids (e.g., with cation conductivity above around 10-10 S sm-1) may be used in the interlayer as binders or components of binders in various embodiments of the present disclosure. In some designs, such polymers may exhibit medium-to-high conductivity (e.g., above around 10-10 S sm-1, or more preferably above around 10-6 S sm-1) for Li ions (in the case of Li or Li-ion batteries).

In some designs, various electrically conductive polymers or copolymers (e.g., with electrical conductivity above around 10² S sm⁻¹), such as those soluble in water (or at least processable in water-based electrode slurries) may be used as binders or components of binders (e.g., components of the binder mixtures or components of co-polymer binders) in the interlayer in the context of this disclosure. In particular, sulfur (S) containing polymers/co-polymers, also comprising aromatic cycles, may be utilized. In some examples, S may be in the aromatic cycle (e.g., as in poly(thiophene)s (PT) or as in poly(3,4-ethylenedioxythiophene) (PEDOT)), while in other examples, S may be outside the aromatic cycle (e.g., as in poly(p-phenylene sulfide) (PPS)). In some designs, suitable conductive polymers/co-polymers may also comprise nitrogen (N) as a heteroatom. The N atoms may, for example, be in the aromatic cycle (as in poly(pyrrole)s (PPY), polycarbazoles, polyindoles or polyazepines, etc.) or may be outside the aromatic cycle (e.g., as in polyanilines (PANI)). Some conductive polymers may have no heteroatoms (e.g., as in poly(fluorene)s, polyphenylenes, polypyrenes, polyazulenes, polynaphthalenes, etc.). In some designs, the main chain may comprise double bonds (e.g., as in poly(acetylene)s (PAC) or poly(p-phenylene vinylene) (PPV), etc.). In some designs, the polymer/copolymer binders may comprise ionomers (e.g., as in polyelectrolytes where ionic groups are covalently bonded to the polymer backbone or as in ionenes, where ionic group is a part of the actual polymer backbone). In some designs, a polymer mixture of two or more ionomers may be used. In some designs, such ionomers may carry opposite charges (e.g., one negative and one positive). Examples of ionomers that may carry a negative charge include, but are not limited to, various deprotonated compounds (e.g., if parts of the sulfonyl group are deprotonated as in sulfonated polystyrene). Examples of ionomers that may carry a positive charge include, but are not limited to, various conjugated polymers, such as PEDOT, among others. An example of the suitable polymer mixture of two ionomers with the opposite charge is poly(3,4-ethylenedioxythiophene) polystyrene sulfonate. In some designs, polymer binders that comprise both conductive polymers and another polymer may be used, which may provide additional functionality (e.g., serve as an elastomer to significantly increase maximum binder elongation or serve to enhance bonding to active materials or current collector, or serve to enhance solubility in water or other slurry solvents, etc.).

In some designs, copolymer binders in the interlayer may comprise halide anions (e.g., chloride anions, fluoride anions, bromide anions, etc.). In some designs, copolymer binders may comprise ammonium cations (e.g., in addition to halide anion, as, for example, in ammonium chloride). In some designs, copolymer binders may comprise sulfur (S). In some designs, copolymer binders may comprise allyl group (e.g., in addition to ammonium cations). For example, such copolymer binders may comprise diallyldimethylammonium chloride (DADMAC) or diallyldiethylammonium chloride (DADEAC). Other suitable examples of such copolymer binder components may include (but are not limited to): methylammonium chloride, N,N-diallyl-N-propylammonium chloride, methylammonium bromide, ethylammonium bromide, propylammonium bromide, butylammonium bromide, methylammonium fluoride, ethylammonium fluoride, propylammonium fluoride, butylammonium fluoride, to name a few.

In some designs, copolymer binders in the interlayer may comprise both poly(acrylamide) and ammonium halides (e.g, ammonium chloride) in their structure. As one suitable example, poly(acrylamide-co-diallyldimethylammonium chloride) (PAMAC) may be used as a copolymer binder in various embodiments of the present disclosure. In some designs, such PAMAC copolymer binders may additionally comprise minor (e.g., less than around 5-10 wt. %) amounts of acrylic acid, carboxylic acid or alginic acid or metal salt(s) thereof (e.g., Na, K, Ca, Mg, Li, Sr, Cs, Ba, La and other salts of such acids).

In one or more embodiments, when forming a polymer binder-comprising interlayer between the polymer binder-comprising electrode and the current collector, the binder in the interlayer and the binder in the electrode may be selected so as to be compatible with each other. In an example, if the selected binders are not compatible with each other, the electrode may de-wet from the interlayer surface (e.g., after coating), form bubbles, reduce (instead of improving) adhesion or induce formation of species that may harm cell performance. In some designs, the polymer binders in the conductive interlayer and the electrode may comprise the same functional groups. In some designs, the polymer binders in the conductive interlayer and the electrode may comprise the same or approximately the same fractions of the same functional groups (e.g., within 10% or less or, in some designs, within 4% or less or, in some designs within 2% or less). In some designs (e.g., in case of aqueous slurries), the polymer binders in the interlayer and the electrode may exhibit the same or similar degree of hydrolysis (e.g. within 10% or less or, in some designs, within 4% or less or, in some designs within 2% or less). In some designs, the polymer binders in the interlayer and the electrode may be of the same or approximately the same (e.g., within 10% or less or, in some designs, within 4% or less or, in some designs within 2% or less) composition. In some designs, the polymer binders in the conductive interlayer and the electrode may exhibit the same or similar molecular weight (e.g., within one order of magnitude). In some designs, the polymer binders in the conductive interlayer and the electrode may comprise the same polymer or copolymer. In some designs, the polymer binders in the conductive interlayer and the electrode may be exactly the same.

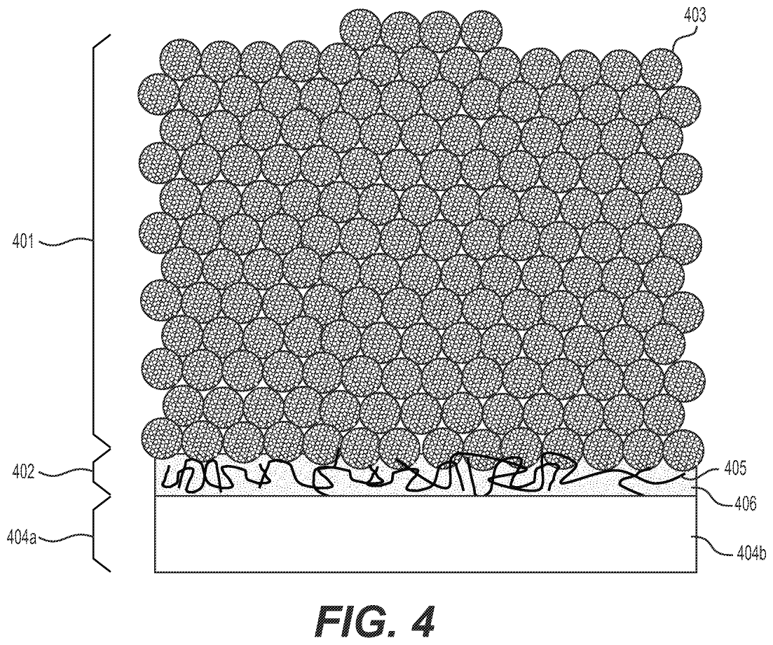

FIG. 4 illustrates a schematic example of the electrode (one side of the electrode 401) comprising (nano)composite particles 403, current collector 404a including a current collector foil 404b and a conductive interlayer 402 in between in accordance with an embodiment of the present disclosure. The conductive interlayer 402 in this example comprises suitable conductive additives 405 (e.g., carbon black or carbon nanotubes or carbon fibers or nanowires or other suitable conductive additives) and a polymer 406. The conductive interlayer 402 electrically connects the current collector and active (ion storing) portion of the electrode and improves adhesion and mechanical robustness of the electrode (and may also reduce electrode resistance).

Referring to FIG. 4, in an example, the conductive interlayer 402 between the electrode 401 and current collector foils 404b to be composed of several sub-layers of distinct composition or to exhibit a gradual change in composition. In one example, the type of the binder or the amount of the binder may be different at the interface with the current collector foil 404b and at the surface of the coating layer. In another example, the type of the conductive additive(s) 405 or the amount of conductive additives may be different at the interface with the current collector foil 404b and at the surface of the coating layer. When more than one sub-layer is used for the interlayer formation, different solvents may be utilized for the deposition of each sub-layer. In some designs, the sub-layers of the conductive interlayer 402 may have different thicknesses.

Referring to FIG. 4, in an example, functional groups (or a substantially thin, e.g., 1-5 nm in average thickness, layer of an organic component, such as a polymer) are added onto the surface of the current collector foil 404b in order to: (i) improved adhesion of the electrode 401 (or the conductive interlayer 402), (ii) improve electrode slurry wetting (or wetting of the pre-deposited conductive interlayer slurry), or (iii) achieve higher adsorption of the components of the slurry (or components of the conductive interlayer slurry) at the interface with the metal for improved electrode performance (improved stability, improved rate, etc.). In one or more embodiments, such functional groups (or a thin polymer layer) may be used to chemically bond the (electrode or interlayer) binder or the conductive additives or the active particles to the current collector foils 404b. In an example, such functional groups may be added by using solution-based chemistry or by using dry chemistry methods (such as plasma, ultra violet (UV)—treatment, ozone treatment, exposure to reactive gases, etc.)

Referring to FIG. 4, in an example, another material layer (which may also be referred to herein as a type of “interlayer”) may be deposited on the top of the electrode 401 to directly contact the separator in a battery stack. In an example, such an interlayer may be used to reduce vertical (in-plane) electrode swelling and improve electrode mechanical properties for cell stability improvements. Similar to the above-described case, the use of mechanically strong 2D and 1D nanomaterials (e.g., graphene, graphite flakes, graphite ribbons, flakes and sheets of various ceramic materials including nitrides, chalcogenides and others, SWCNTs, DWCNTs, MWCNTs, carbon (nano)fibers, suitable (compatible with the electrode) metal (nano)wires and (nano)fibers, suitable (compatible with the electrode) ceramic nanowires or nanofibers (for example, nanowire or nanofibers comprising aluminum oxide, zirconium oxide, magnesium oxide, and other oxides; titanium nitride, boron nitride, various other nitrides; various other suitable ceramic materials), suitable polymer or organic (nano)fibers, various structural composite and core-shell (nano)fibers, (nano)wires and nanotubes, to provide a few examples) within such a layer (interlayer), may be used. In one or more embodiments, the conductive interlayer 402 at the metal current collector 404b-electrode 401 interface may be used in combination with another layer (interlayer) deposited on the top electrode surface.

Referring to FIG. 4, in an example, exposure of the current collector foils 404b to electrolyte within a certain potential range may be undesirable as this may lead to current collector foil corrosion or weakening of its mechanical properties (e.g., particularly in combination with the subsequent cycling stresses during charge-discharge cycles). In such a case, (i) the presence of the open porosity through the conductive interlayer 402 may be reduced or eliminated, and (ii) polymer binders in the conductive interlayer 402 that exhibit a low permeability to electrolyte solvent may be used (e.g., low swelling in electrolyte, such as to below 10 vol. %, or to below 2 vol. %) and/or a low permeability to active ions (e.g., to Li⁺ ions in case of Li-ion batteries).

It will be appreciated that, with respect to FIG. 4, the “electrode” layer 401 is separately described from the conductive interlayer 402 and the current collector foil 404b. However, in some other examples, the electrode 401 may be understood as a combination of all the components, including the foil 404b and the conductive interlayer 402.

Referring to FIG. 4, in an example, a suitable thickness of the conductive interlayer 402 may range from around 5 nm to around 10 μm (e.g., from around 50 nm to around 1 μm). In certain applications, a larger thickness (e.g., greater than 10 μm) may reduce the energy density of the cell to an undesirably low level and, in some cases, may increase first cycle losses. On the other hand, in certain applications, a lower thickness (e.g., below 5 nm) may be insufficient for providing the desired enhancement in performance. Hence, a target thickness of the conductive interlayer 402 may also depend on the particular electrode and cell designs as well as the conductive interlayer composition and properties.

Referring to FIG. 4, in an example, the current collector foils 404b may comprise more than one metal layer (e.g., 2 or 3 or more layers). In an example, such layers may be of different compositions (e.g., different metals, such as Cu and Ni or Cu and stainless steel or Cu and Ti or other combination of metals and metal alloys). Some current collector foil layers may help to enhance foil mechanical properties, while other current collector foil layers may help to enhance electrical conductivity or ability to weld or corrosion resistance or adhesion to the electrode 401 or provide other useful functions.

Referring to FIG. 4, in an example, a layer of carbon film may be deposited on metal current collector foils 404b (e.g., Cu or Al, etc.) to improve electrode performance (in some examples, to improve stability upon contact with electrolyte; in other examples, to reduce electrical resistance). In an example, such a carbon layer may be deposited using physical vapor deposition (PVD; e.g., by sputtering or evaporation, etc.) or chemical vapor deposition (CVD). In an example, CVD may be plasma-enhanced (e.g., in order to increase the deposition rate or reduce the deposition temperature). In the case of CVD, carbon may be deposited using precursors including, but not limited to: acetylene, propylene, ethylene, methane, hexane, cyclohexane, benzene, xylene, naphthalene, anthracene, to name a few. In an example, a two-step process may be employed, wherein conditions for the initial surface layer are tuned to form a high quality C/metal foil interface and a second step is utilized for rapid deposition of the remainder of the carbon film. In one illustrative example, the first step is selected to grow graphene on metal (e.g., Cu) foil. As an example, low pressures (e.g., less than 100 Torr) and high temperatures (e.g., from around 700 to around 1050° C. or slightly below a melting point of the corresponding metal) may be used, with the time adjusted to grow, for example, 1-10 graphene layers (with the understanding that too many layers may reduce conductivity and induce delamination during cooling). The second step may be tuned for rapid deposition of carbon while avoiding gas-phase nucleation of carbon particles (the conditions for which depend on the particular precursor).

Referring to FIG. 4, in an example, metal foils 404b may be pre-treated prior to carbon layer deposition. For example, Cu foil may be pre-treated to remove any oxide layer by heating up to 1000° C. in H₂-comprising gas (such as pure H₂, H₂/Ar, H₂/N₂, H₂/He or other suitable mixtures) before carbon film deposition.

Referring to FIG. 4, in an example, carbon nanotubes (CNTs) or vertical graphene ribbons may be grown on a metal current collector foil surface for improved performance. In some examples, metal catalyst nanoparticles (e.g., Fe, Ni, Co, Pt, Pd, Cu, Mn, Mo, Cr, Al, Au, Mg, Sn, etc.) may be deposited on a foil surface, followed by carbon deposition using precursors, such as acetylene, propylene, ethylene, methane, hexane, cyclohexane, benzene, xylene, naphthalene, anthracene, or others. In an example, the suitable length of CNTs or graphene ribbons may range from around 50 nm to around 10 μm, to allow for sufficient flexibility and interaction with active particles, without adding too much volume to the current collector.

In one or more embodiments, only certain types of metal foils may be used in combination with the above-discussed volume-changing electrodes (e.g., electrodes comprising the nanocomposite electrode materials (for example, conversion-type and alloying-type materials) that experience certain volume changes during cycling (for example, moderately high volume changes (8-160 vol. %) during the first cycle, moderate volume changes (5-50 vol. %) during the subsequent charge-discharge cycles) and an average size in the range from around 0.2 to around 20 microns). Such metal foil types may be selected based on their mechanical properties, their electrical properties, or a combination thereof. In one example, the foil is selected so as to sustain mechanical elongation of at least 3% prior to fracture. In one or more embodiments, the foil is selected so as to sustain 1,000 loading-unloading cycles at mechanical elongations of at least 0.5% (e.g., at least 1%) prior to fracture. In a further example, the foil is selected so as to exhibit average grain size in excess of approximately 0.25 μm (e.g., in excess of 2 μm). In a further example (e.g., if sufficient elongation may be achieved), the foil may be formed from a metallic glass. In for a further example, the foil comprises less than 0.1 at. % oxygen. In a further example, the foil is annealed in a reducing environment (e.g., in an H₂-containing or hydrocarbon-gas (e.g., methane, acetylene, propylene, etc.) containing environment) to enhance grain size and reduce oxygen content. In for a further example, the foil is perforated (e.g., with holes) in order to enhance its mechanical stability (e.g., resistance to crack propagation during cycling). In a further example, the fraction of holes in the foil may range from around 0.01% to around 30%. In a further example, a suitable diameter of the holes may range from around 20 nm to around 20 μm. In a further example, the metal foils may comprise mechanical reinforcement additives (such as various 1D additives, including but not limited to various ceramic (e.g., aluminum oxide, zirconium oxide, silicon oxide, magnesium oxide, copper oxide, other metal oxides, various metal nitrides, carbon, etc.) nanowires, nanotubes and nanofibers). In a further example, current collector foils may comprise internal (closed) pores. In a further example, current collector foils may comprise open pores. The characteristic average size (e.g., diameter or width) of the pores may range from around 5 nm to around 5 μm. In an embodiment, the average total pore fraction may range from 0 to about 75 vol. %.

Copper (Cu) foils are traditionally used as anode current collectors in some conventional low potential anodes (such as those based on graphite or Si-graphite mixtures or other low-potential anodes). However, such current collectors may experience undesirable volume changes and, in some cases, fractures during cycling (e.g., particularly during the initial so-called “formation” cycles) due to the volume-changing nature of the high-capacity (nano)composite anode particles that adhere to the current collectors. Alternative metals, such as nickel (Ni), titanium (Ti), iron (Fe), vanadium (V), their alloys, etc., exhibit better mechanical properties (such as higher strength, higher fracture toughness, higher resilience to creep and fatigue, to name a few). However, these alternative metals may be more difficult to produce in a thin foil form (e.g., 5-20 μm) and may be more expensive. In addition, these alternative metals may exhibit lower electrical conductivity. For various reasons, such materials are not used in conventional commercial Li-ion battery cells as anode current collectors. However, in in one or more embodiments, the anode current collector foils (or meshes or foams or porous foils, etc.) may comprise Ni, Ti, Fe, or other metals to achieve desirable performance and mechanical stability. In an embodiment, such anode current collector foils may be thin (e.g., 5-20 μm) and comprise 5-100 wt. % of Ti, Ni, Fe.

In one or more embodiments, thin coatings (e.g., in the range from 0.01 to 3 μm) of copper (Cu) on the surface of Ni, Ti, Fe, or carbon—based foil (or mesh or foam) current collectors may be produced. The deposition of Cu may be performed by electrodeposition, sputtering, or other suitable methodologies. The layer of Cu may: (i) improve adhesion to the electrode; (ii) improve electrical conductivity; and (iii) improve welding of the tabs, or any combination thereof. In an example, the strength and mechanical properties of Cu foils may be enhanced be utilizing Cu alloys comprising Ni, Fe, Ti, Mg, Co, Sn, Si, Cr, Zn, Al or other suitable elements (e.g., that exhibit minimal alloying with Li at low electrochemical potentials or utilized in very small amounts, such as below 1-2 wt. %) in amounts (total of all non-Cu elements) exceeding approximately 2 wt. %. In one illustrative example, Cu alloy may comprise Cu—96.2%; Ni—3%, Si—0.65%, Mg—0.15% (i.e., so-called copper alloy 7025). In another illustrative example, Cu alloy may comprise Cu—96.8%; Ni—1.5%, Co—1.1%, Fe—0.08%, Si—0.6% (i.e., so-called copper alloy 7035).

In one or more embodiments, the strength and mechanical properties of the anode current collectors as well as adhesion to the electrodes may be enhanced by incorporating mechanically strong carbon or metallic (e.g., Ni, Fe, Ti, and other metals and metal alloys, including Cu) or ceramic (e.g., oxides, nitrides, carbides, etc.) (nano)fibers or nanotubes or nanowires or flakes into the bulk of the current collectors or depositing such fibers or nanotubes or nanowires or flakes onto the surface of the anode current collectors. In one or more embodiments, nonwoven or woven fabrics comprising carbon or metal (e.g., Ni, Fe, Ti, and other metals and alloys) or ceramic (e.g., oxides, nitrides, carbides, etc.) (nano)fibers or nanotubes or nanowires may be impregnated with Cu or Cu alloys for use as anode current collectors. In one or more embodiments, the average thickness of such composite current collectors may range from around 3 to around 25 microns. For certain applications, a smaller thickness may not be sufficient to provide the required mechanical strength or conductivity, while a larger thickness may undesirably reduce the volumetric or gravimetric energy density of cells and increase their cost to impractical levels.

In one or more embodiments, current collectors may comprise open or closed pores (channels) in the range from 10 nm to about 10 micron. Somewhat counterintuitively, the presence of such pores may improve durability of the electrode in embodiments of the present disclosure. Such pores (e.g., if open or if propagating to the surface of the current collector) may also improve adhesion between the electrode and the current collector.

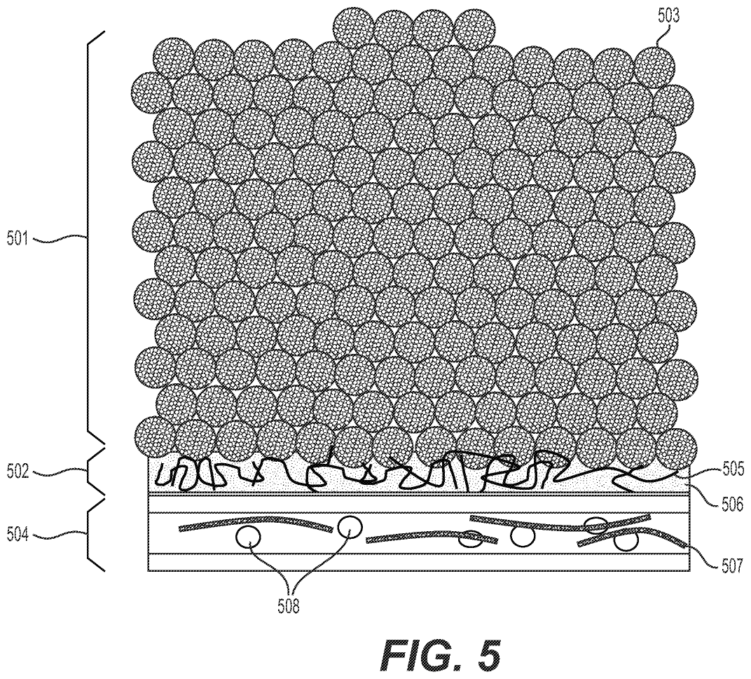

FIG. 5 illustrates a schematic example of one of the suitable electrode embodiments, where the electrode 501 comprising (nano)composite electrode particles 503, a conductive interlayer 502 and a current collector 504 of a suitable composition comprising multiple layers, reinforcement fibers 507 and pores 508. The conductive interlayer 502 comprises in this example suitable conductive additives 505 and a suitable polymer 506.

In some designs, some of the conversion-type cathodes may similarly benefit from replacing Al by Ti or Ni current collector foils (or porous foils or meshes or foams). In this case, in some designs, these current collectors may be coated with a thin (e.g., in the range from 0.01 to 3 μm) layer of Al in order to achieve higher electrochemical stability, higher conductivity, better adhesion of the electrode or better welding or any combination thereof. In some designs, the strength and mechanical properties of the cathode current collectors as well as adhesion to the electrodes may be enhanced by incorporating mechanically strong carbon or metallic or ceramic (nano)fibers or nanotubes or nanowires or flakes into the bulk of the current collectors or depositing such fibers or nanotubes or nanowires or flakes onto the surface of the cathode current collectors. As previously described, the cathode current collectors may also comprise pores.

In one or more embodiments, a surface of any of the above-described nanocomposite electrode materials is functionalized. In a further embodiment, chemical bonds are formed with the electrode binders or conductive additives in any of the above-described nanocomposite electrode materials to improve performance.

In one or more embodiments, conductive carbon may be provided on a surface of any of the above-described nanocomposite electrode materials. For example, the conductive carbon may be provided as a part of the shell in core-shell composites or as part of the composite.

In one or more embodiments, the surface of any of the above-described (nano)composite volume-changing active particles may comprise carbon.

In one or more embodiments of the present disclosure, chemical moieties to carbon, or functionalization, of the carbon (or carbon containing) surfaces of the electrode particles may be added. In one example, changes in the carbon surface chemistry may provide improved dispersibility during electrode slurry preparation. Furthermore, changes in the surface chemistry may lead to favorable changes in the interfacial interactions with active particles, conductive additives, binders, electrolyte, SEI, or any combination thereof. In an example, functionalization of carbon may introduce a handle for the formation of strong covalent bonds between various carbon-containing materials (e.g., active electrode particles that comprise carbon on their surface or conductive additives) and (in some cases) between carbon-containing materials and a binder. In some cases, even when the surfaces of the electrode particles do not comprise carbon, similar functional groups (or small molecular chains or small dendritic structures, e.g., with less than 80 atoms, chemically attached to the electrode particle surface) may also be used.

In a further embodiment, introduction of polar groups to the (carbon) surface may provide improved dispersibility in polar solvents such as water, N-methylpyrrolidinone, N,N-dimethylformamide, alcohols, which allows for more uniform slurry mixtures and thus a more uniform electrode. Introduction of non-polar groups, such as alkyl chains, may provide improved dispersion in non-polar solvents such as aliphatic hydrocarbons.

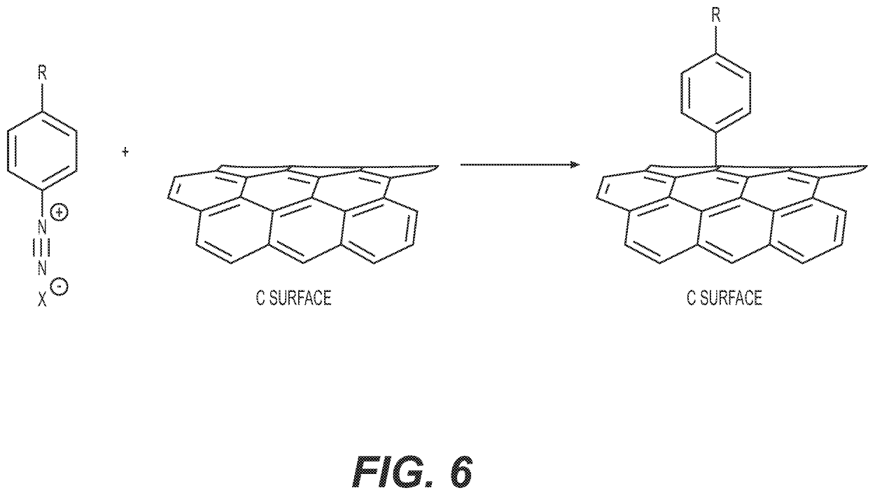

FIG. 6 provides an illustrative example for the functionalization of the active particles. In this example, the functionalization may be accomplished by reaction with a substituted aryldiazonium group, where the aryl group is substituted with any desired chemical moiety, to form a carbon-carbon bond between the carbon surface and the ipso carbon (where the diazonium was attached to the aryl group) with concomitant release of dinitrogen. The substituted aryl diazonium may be isolated or synthesized in situ without isolation before reaction with carbon. In an example, the carbon material itself may be reducing enough for the reaction to proceed. In an alternative example, a reducing agent may be required. In an example, the 2, 3, 4, 5, and/or 6 (0-3 of these positions may be substituted) position of the phenyl group may be substituted with acid groups, alcohol groups, amines, sulfates, ammonium, amides, esters, ethers, alkyl, alkenes, alkynes, phosphates, nitrates, halides, or aryls. These groups may be directly attached to the aryl group or to linear or branched alkyl chains that are attached to the carbon. In an example, the solvent for the reaction may be water, alcohols (for example, methanol or ethanol), 1,2-dicholorbenzene, or acetonitrile. In a further example, the extent of functionalization of the carbon material may be controlled by controlling the amount of aryl diazonium present (using the aryl diazonium as the limit reagent).

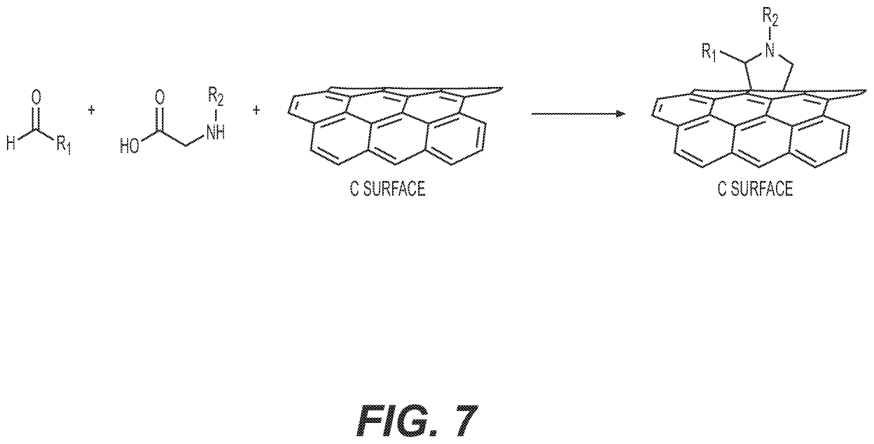

FIG. 7 provides another illustrative example of a functionalization of carbon materials. In the example of FIG. 7, the functionalization of carbon materials occurs by the reaction with an aldehyde and amino acid. Suitable functionalization of the carbon surface of the active particles may be accomplished by reaction of an amino acid and an aldehyde or ketone with the carbon material. Functional groups can be introduced at both the R¬¬1 and R2 positions (as designated in FIG. 7). In an example, the amino acid and aldehyde react to form an azomethine ylide in situ, which reacts with the carbon surface to from a pyrrolidine ring. In a further example, the reaction may take place in toluene or N,N-dimethylformamide, and may require elevated temperature up to and including reflux of the solvent.

Referring to FIG. 7, in an embodiment, fluorides may be appended to the carbon surface by reaction with fluorine. Reaction with NF₃ at elevated temperature may fluorinate the carbon surfaces. Alternatively, atomic fluorine may be generated from NF₃ in a plasma source. The degree of fluorination of the carbon may be tuned by reaction time, temperature, flow rate, and/or pressure of the reaction.

Referring to FIG. 7, in an embodiment, by using an oxidizing agent, oxygen-containing functionalities may be successfully added to the carbon surface for improved electrode performance. Functionalities at the surface may include alcohols (i.e., phenolic functional groups), carboxylic acids, epoxides, lactones, or ketones. Suitable examples of oxidizing agents include, but are not limited to nitric acid, mixtures of sulfuric acid and nitric acid, mixtures of hydrochloric acid and nitric acid, hydrogen peroxide, mixtures of sulfuric acid and hydrogen peroxide, acetic acid, to name a few. In an example, reaction temperatures may range from around −10° C. to around +200° C., depending on the solvent used (to the point of the reflux of the reagent/solvent). In a further example, reactions may be done in an aqueous solution.

Formation of bonds between the active particles and binder or conductive carbon additives may provide many benefits, such as increased mechanical stability of the electrode, help maintaining electric conductivity (despite SEI formation and growth), stabilization of various interfaces, reduction of the degree of swelling of the electrode/binder interface and others, or any combination thereof.

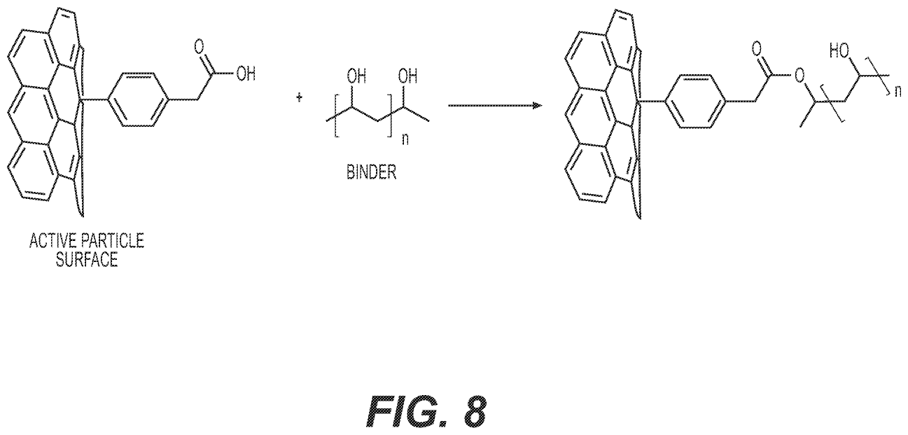

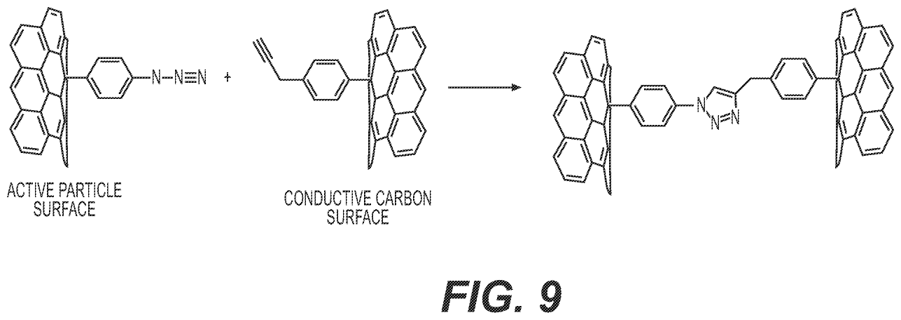

In one or more embodiments, to form bonds between electrode components, complimentary functional groups that can form covalent bonds may be introduced. These functional groups may be either integrated into the material itself (for example, alcohol groups in PVA binders or acid groups in PAA binders), be introduced during a surface funcationalization process, or be a part of separate additive(s). In one embodiment, these bonds do not form (or do not form to a significant extent) during slurry mixing or coating. Instead, in an embodiment, these bonds may form at elevated temperature(s) or reduced pressure(s) during electrode drying. This approach may be used to form linkages between active particles and binder(s), active particles and conductive additives, conductive additive particles and other conductive additive particles, active particles and other active particles, binders and conductive additives. Examples of types of bond-forming complimentary functional groups include, but are not limited to, esterification of alcohols and acids to form esters (as illustrated in example of FIG. 8); Diels-Alder reactions of dienes and unsaturated hydrocarbons to form cyclic hydrocarbons; 1,3-cycloaddition of azides and alkynes to form 1,2,3-triazoles; cycloaddition of tetrazine and alkenes to form 1,2-diazines; cycloaddition of tetrazoles and alkenes to form 1,2-diazoles; nucleophilic ring-opening of epoxides or aziridines by a nucleophile (for example, a carboxylic acid or carboxylate); reaction of isocyanates and alcohols to form carbamates; Williamson reaction of alkoxides and alkyl halides to form ether bonds. FIG. 9 illustrates an example of a reaction between an azide and an alkyne to form a triazole to link active particles and a conductive (e.g., carbon) additive.

In a further embodiment, covalent bond forming methodologies may be used with a separate crosslinking additive included to connect electrode components. A crosslinking reagent that contains two or more of the complimentary functional groups on one or more components in the electrodes may be used to link the electrode components.

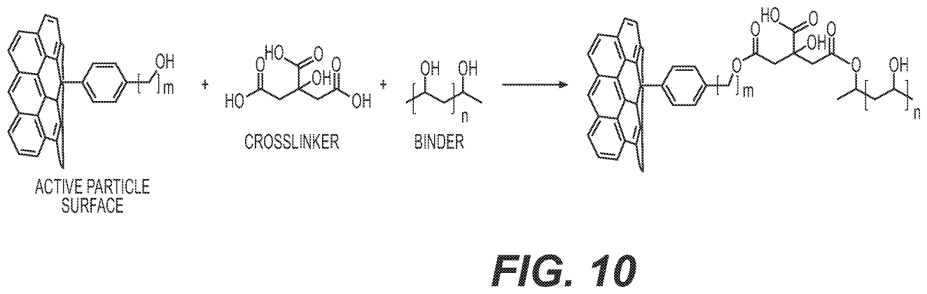

FIG. 10 illustrates crosslinking between active particles and a binder by an esterification reaction with citric acid in accordance with an embodiment of the disclosure. FIG. 10 depicts an example where the crosslinker is citric acid, which contains three acid groups. In an example, the crosslinker may be used to crosslink between the active particles and binder if they both contain alcohol groups.

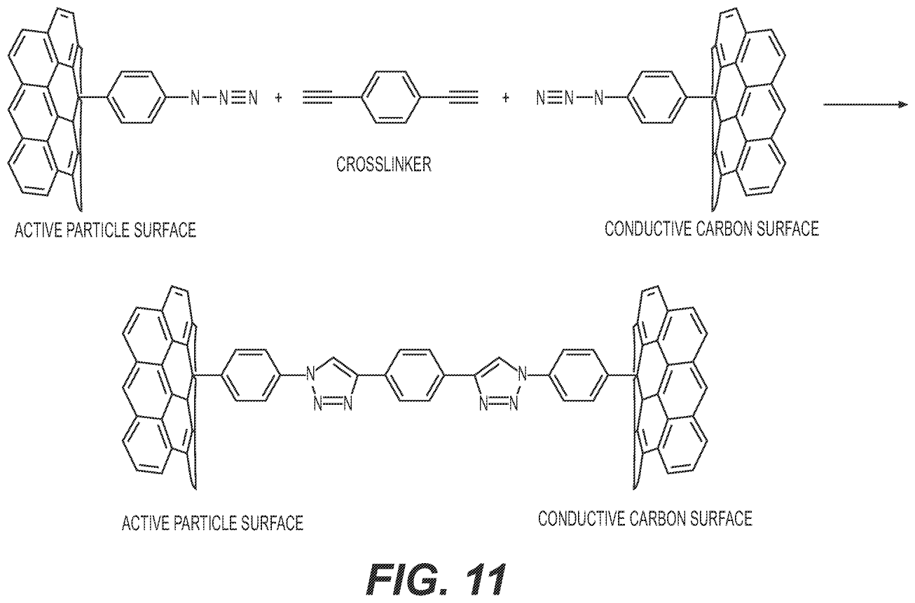

FIG. 11 illustrates crosslinking between active particles and conductive carbon additive using 1,3-cycloaddition of surface azides with 1,4-diethynylbenzene in accordance with an embodiment of the disclosure. FIG. 11 depicts an example where 1,4-diethynylbenzene may be used as a crosslinker that contains two alkyne groups (to crosslink, for example, active particles and conductive carbon additives).

Crosslinkers may be used to link between specific components of the electrode or between two or more electrode components. A crosslinker may be used to link between polymer chains of a binder to decrease swelling in electrolyte. Alternatively, a crosslinker may be used to link between the binder and active particles to increase mechanical stability of the interface. Alternatively, a crosslinker may be used to link between active particles and a conductive additive to help maintain electrical conductivity despite SEI formation.

In an embodiment, if the crosslinked material is conjugated (e.g., as in FIG. 11), electrons can travel through the pi-system of the crosslinker to maintain or enhance electric conductivity between electrode components.

In some designs, conductive additives may be attached to the volume-changing (nano)composite electrode particles by other mechanisms. In one example, conductive additives (e.g., carbon nanotubes or graphene or metal nanoparticles or metal nanowires) can be grown directly on the surface of the electrode particles (e.g., by CVD or by solution chemistry routes). In another example, conductive particles (e.g., of various shapes and sizes) can be attached to the surface of the electrode particles by making the surface of each (or most) particle(s) charged and by using the opposite charge on the electrode particles vs. conductive additive particles. In yet another example, the conductive particles can be attached to the surface of the electrode particles using an organic (e.g., a polymer) binder and by carbonizing the binder to form a conductive carbon interlayer (e.g., which effectively acts as a conductive glue) between the conductive additive(s) and the electrode particle(s). In yet another example, CVD can be used to deposit a carbon layer on the mixture of conductive additive particles and active electrode particles, thereby depositing carbon at the contact points between the electrode particles and conductive additives. The CVD carbon layer may similarly act as a conductive glue to attach conductive additive(s) to the electrode particle(s).

In an embodiment, a target wt. % of slurry components, given as a ratio of the mass of non-active components to the external surface area of (nano)composite active electrode particles, may exhibit values ranging from about 1 to about 5,000 m² active/g non-actives (e.g., around 5 to around 200 m² active/g non-actives). The target wt. % of slurry components may be tailored for a particular electrode composition and may depend on factors such as the size of the active particles, type of conductive additives, surface chemistry of the conductive additives, surface chemistry of the active particles, density of the particles, volume changes during cycling, type and molecular weight of the binder(s), thickness of the electrode, density of the electrode, or any combination thereof. In an example, the active/non-active ratio for spherical active particles may decrease with increasing particle size, due to greater strain at the particle exterior. The exact composition of the (nano)composite active electrode particles may impact both mechanical stability of the casted electrodes and the cell-level rate performance (e.g., excessive filling of interstitial space between the active (nano)composite particles with inactive material may reduce ion transport and have a negative effect on charge/discharge rate performance; insufficient amount of binders may induce mechanical failure; insufficient amount of conductive additives may reduce both cycle stability and electrode rate performance; etc.). Multiple examples of suitable binders and conductive additives are described hereinabove. When a binder adheres to conductive additives (e.g., which may be undesirable in some applications), the ratio of the binder to the conductive additives may be sufficient for the binder to still be available to bind to (nano)composite active particle surfaces (e.g., if an insufficient binder/additive ratio is used, the binder may coat the surface of the conductive additives, weakening active particle connections). In one example embodiment with mostly (nano)composite active particles with a carbon surface layer and particle size mostly in the range from about 0.5 to about 10 μm, a 0.002-0.200 g SWCNT per g of polyvinyl alcohol (PVA) binder may be used. The value may be further increased by improving the affinity between binder and active particles, e.g., by functionalization of carbon particle surfaces, or by inclusion of a nonpolar binder constituent with a greater affinity for non-functionalized carbon surfaces.

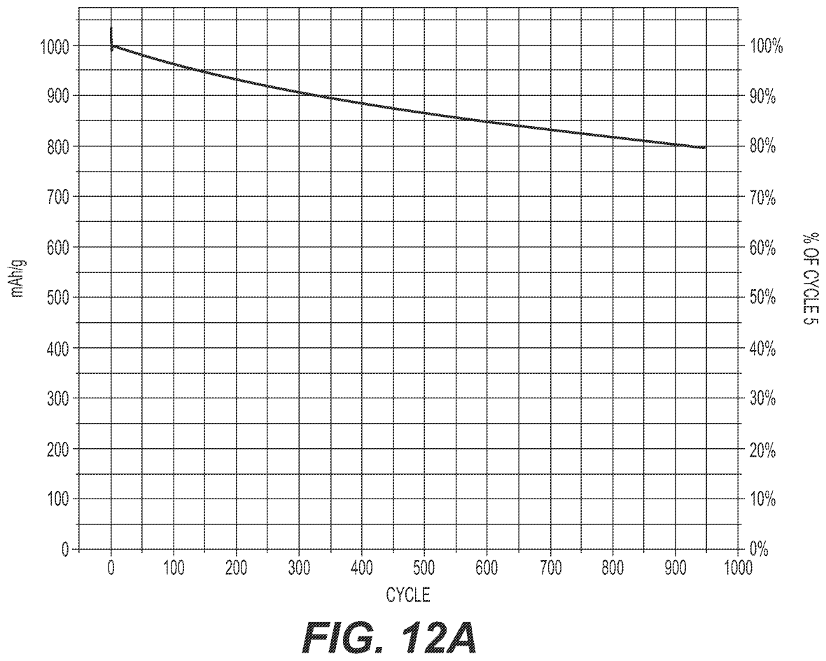

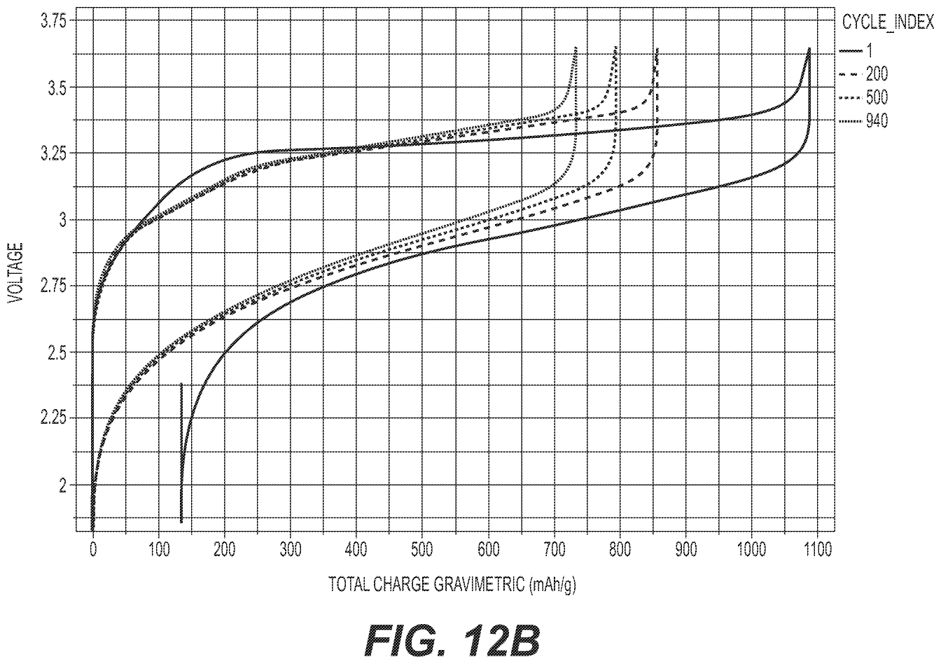

FIG. 12A depicts a graph showing anode performance in terms of mAh/g as a function of the number of charge/discharge cycles in accordance with an embodiment of the disclosure. FIG. 12B depicts a graph showing anode performance in terms of voltage as a function of mAh/g at different numbers of charge/discharge cycles in accordance with an embodiment of the disclosure.

Referring to FIGS. 12A-12B, the anode is for Li-ion batteries and comprises Si-comprising (nano)composite active particles (with an average diameter in the range from around 1.5 to around 2.5 micron), PVA binder and SWCNTs as conductive additives (amount of SWCNTs is less than 1 wt. %). FIGS. 12A-12B shows that cycle stability of a matched full cell with a lithium iron phosphate cathode and Si-comprising (nano)composite anode, which exceeds 900 cycles to 80% of the cycle 5 capacity. In FIGS. 12A-12B, it is assumed that the charge-discharge cycling was implemented at a rate of C/2 (except the first cycle, which is cycled at the rate C/10). In an example, the specific capacity of the anode modeled in FIGS. 12A-12B exceeds that of conventional commercial graphite anodes by nearly 3 times.

In some applications, an opposite charge may be induced on the surface of conductive additives and the (composite) electrode particles in order to enhance their contact area and contact strength and achieve more uniform mixing. For example, a positive charge may be introduced on the surface of the composite particles and a negative charge may be introduced on the surface of conductive additives. In another example, a negative charge may be introduced on the surface of the composite particles, and a positive charge may be introduced on the surface of conductive additives. In some applications, a chemical reaction is induced between conductive additives and the electrode particles during or after electrode drying.

In some applications, more than one type of conductive additive may be used. In an example, one type of conductive additive is chemically bonded to the surface of electrode particles. In this case, a requirement for the conductive additive to lack swelling for maintaining stability of the electrode particle/conductive additive interface may be substantially reduced or even completely avoided. In one example, short (e.g., 0.01-10 micron) carbon nanofibers, carbon nanotubes, or graphene/graphite ribbons may be grown from the surface of electrode particles (e.g., by using catalyst-assisted chemical vapor deposition, CVD, or other mechanisms). In another example, a mixture of conductive carbon additive particles (e.g., carbon black, carbon nanotubes, etc.) with one charge and electrode particles with the opposite charge may be additionally mixed with a small sacrificial binder content and then carbonized. The carbonized binder may firmly (e.g., and permanently) attach some of the carbon additives to the surface of the electrode particles. Such electrode particles/carbon additives composites may be used in slurries with various suitable binders and additional conductive additives to form (or cast) more stable electrodes that experience moderate volume changes during cycling (e.g., as applicable in various embodiments of the present disclosure).

In some applications, two or more conductive additives with different surface charges or different surface chemistries may be used. In an example, when one type of additive exhibits higher affinity to the electrode particles, such an additive may be selected to form a uniform coating around the electrode particles. Such an additive may also be selected to form chemical bonds with the electrode particles at some stage of the electrode assembling or slurry preparation. The second additive may be incorporated into the binder in higher proportion than the first additive so as to form robust and uniform binder/additive (nano)composites that yield stable electrodes.

In some applications, two or more conductive additives may be selected to achieve different functions. In one example, a first type of additive (e.g., with larger dimensions or higher conductivity) may be selected to provide higher electrical conductivity within the electrode as a whole, while a second type of conductive additive may be selected to ensure that each individual electrode particle is effectively electrically connected to multiple neighboring electrode particles and the first type of additive, thereby forming an efficient conductive network that results in higher capacity utilization of the electrode material. In another example, one type of additive may be selected to perform multiple functions (e.g., to enhance both electrical conductivity and mechanical stability of the electrodes or to enhance electrical conductivity of the electrode and provide faster ionic pathways (e.g., if it is porous or if it prevents electrode pore closing)). One type of conductive additive may also assist in better dispersing the second type during the slurry mixing. For example, a mixture of two of conductive additives may be in the same slurry in accordance with any of the following example configurations: (i) various types of single walled carbon nanotubes (SWCNTs) (with or without surface coatings); (ii) various types of multiwalled carbon nanotubes (MWCNTs) (with or without surface coatings); (iii) various types of carbon black (including those that are annealed at above 1000° C. in inert environment); (iv) various types of carbon fibers (including those that are annealed at above 1000° C. in an inert environment); (v) various types of carbon nanofibers; (vi) various types of metal nanowires (without or with protective or functional surface coating layers) (e.g., Cu, Fe, Ti, or Ni nanowires for low potential anodes in Li-ion batteries, such as Si comprising anodes; Al nanowires for cathodes or high voltage anodes in Li-ion batteries, or other nanowires (e.g., Ni or Ti nanowires) for various aqueous batteries, etc.); (vii) various types of carbon-coated or metal- (e.g., Cu, Fe, Ni, Ti or Al, etc.) coated ceramic nanowires or fibers (e.g., Al₂O₃ nanowires or fibers); (viii) various types of carbon onions; (ix) various types of graphite ribbons (including metal-coated graphite ribbons); (x) various types of metal (e.g., Cu, Fe, Ni, Ti or Al, etc.) nanoparticles (with or without coatings by a protective or functional surface layer); and/or (xi) various types of metal (e.g., Cu, Fe, Ni, Ti or Al, etc.) (nano)flakes (with or without coatings by a protective or functional surface layer), to name a few examples. The surface chemistry of each type of such additive could be individually tailored in a cell-specific manner to improve performance.

In some applications, salts are added into the slurry in order to (i) improve dispersion (mixing) of the components; (ii) control spacing between the electrode particles (e.g., if uniform but non-zero spacing is desired to reduce electrode-level volume changes during the first and subsequent cycling—which may be achieved, for example, by the extracting/washing the salt from the dried and assembled electrode but prior to the electrode use in cells); (iii) control (e.g., reduce) solubility of the polymers in a slurry (e.g., in order to precipitate them faster during the drying of the electrode and thus reduce electrode shrinking during electrode drying); (iv) provide additional control in the interaction between the slurry components (electrode particles, additives, binders, etc.); (v) tune the interactions between the electrode (or additives or binders) with electrolytes; and/or (vi) serve other functions. Such salts may be washed away (e.g., extracted) from the electrode prior to its use (assembling) in cells. A broad range of salts may be used. Depending on the particular cell chemistry and electrolyte composition, illustrative examples of salts may include, but are not limited to various alkali (e.g., Li, K, Na, Ca, etc.), metal salts (for example, various inorganic salts, such as LiCl, LiBr, LiI, Li₂SO₄, LiNO₃, LiClO₃, LiClO₄, H₃BO₃, Li₃PO₄, Li₃O₃P, Li₄O₇P₂, or Li₃NO₃S, among others, or various organic salts, such as Li salts of carboxylic acids (formic acid, acetic acid, propionic acid, butyric acid, sulfonic acids, valeric acid, caproic acid, oxalic acid, lactic acid, malic acid, benzoic acid, citric acid, benzenecarboxylic acid, carbonic acid, carbolic acid, hydroxymethanoic acid, etc.), of thiolic acids, uric acid, 2-aminoethanesulfonic acid, 4-methylbenzenesulfonic acid, trifluoromethanesulfonic acid, aminomethylphosphonic acid, to name a few suitabke examples). In some designs, the amount of salt in a slurry may be in the range from about 0.00000025 vol. % to about 25 vol. %.

In some applications, the overall volume fraction of all conductive additive particles within the electrode is restricted to less than 5 vol. % (e.g., less than 2 vol. %). By mass, the fraction of all conductive additive particles within the electrode may be less than 7 wt. % (e.g., less than 3 wt. %) if only carbon materials are used as conductive additives and less than 10 wt. % (e.g., less than 5 wt. %) if some of the conductive additives comprise suitable metals. In one or more embodiments, a higher volume fraction of conductive additives may reduce ionic transport and volumetric capacity of electrodes and may increase the extent of undesirable side reactions. In one or more embodiments, a higher gravimetric (mass) fraction of conductive additives may reduce the specific capacity of the electrodes.

In some designs, porous fibers are used in the electrodes and electrode slurry formulations. The pores in such fibers may be utilized for several functions. First, the porous fibers may accommodate some of the stresses during the volume expansion of the volume changing electrodes (e.g., Si-comprising and others) by compression, and thus improve electrode mechanical stability (and also reduce stresses on the metal current collectors). Second, the porous fibers may be use to enhance ion transport from the surface of the electrode into its bulk (e.g., interior areas of the electrode), which may become particularly assist ion transport for thicker electrodes or for electrodes that undergo initial expansion (e.g., and thus may reduce internal porosity for ion transport). In an example, in order to warrant their electrochemical stability, the porous fibers may be composed of (i) polymers; (ii) carbon; (iii) metals that do not undergo electrochemical alloying with Li (e.g., Ni, Cu, Ti, or Fe) at the electrode potentials experienced during cell operation (in cases when they are used in low-potential anodes for Li ion batteries, such as Si-based and the like); (iv) ceramic (oxides, nitrides, etc.) that do not exhibit conversion reactions with Li (such as aluminum oxide, zirconium oxide for anodes and many other oxides, nitrides, etc. for cathodes) at the electrode potentials experienced during cell operation (in cases when they are used in low-potential anodes for Li ion batteries, such as Si-based and the like). In a further example, in order to warrant accurate cathode:anode capacity matching, the porous fibers may be uniformly distributed within the electrode and be of moderate dimensions (e.g., a diameter of less than 20% of the electrode thickness, less than 5% of the electrode thickness, etc.). In one or more embodiments, a suitable length of such porous fibers may be in the range from about 20% of the electrode thickness to around 200 times the electrode thickness (e.g., from around 50% to around 10 times the electrode thickness). For 50-100 micron thick electrodes, this translates into a length from around 10 microns to around 2 cm in a broader case. In an example, the volume fraction of such porous fibers may range from around 0.01% to around 20% of the electrode volume (e.g., in some applications when thicker electrodes are used or when the volume expansion is relatively large in the “formation” cycles, from around 1% to around 20%). In a further example, the pore fraction in such porous fibers may range from around 10 vol. % to around 97 vol. % (e.g., from around 30 to around 85 vol. %, depending on the mechanical properties of the fiber material). In some applications, smaller pore volume (e.g., pore fraction) may be ineffective for ion transport and stress accommodation, while larger pore volume may not allow these fibers to maintain sufficient mechanical integrity during the slurry and electrode formulations (including calendaring).

In some designs, sacrificial fibers instead of porous fibers are used in the electrodes and electrode slurry formulations. In an example, such sacrificial fibers may be removed from the electrode (e.g., after electrode calendaring or densification to maintain high volumetric capacity of the electrodes) by using solvents or by heat treatment (e.g., evaporation, carbonization, thermal decomposition, etc.) or by other mechanisms. If solvents are used for their removal, in an example, such sacrificial fibers may comprise polymers or sugars or salts that may be easily dissolved by exposing the electrode to a solvent bath. The volume fraction and other properties of sacrificial fibers may be similar to that of the porous fibers.

In some designs, porous platelets or porous sacrificial platelets are used instead of fibers (e.g., porous fibers or sacrificial fibers) in the electrodes and electrode slurry formulations.

In some designs, porous or sacrificial platelets or fibers are attached to the current collectors (e.g., vertically) prior to coating the current collectors with slurries. In the case of vertical attachment, in an example, these additional ion transport channels (pores) in the electrode may be oriented more perpendicular to the electrode and thus provide faster ion transport. Similarly, this “more perpendicular” orientation may be more effective in accommodating stresses within the electrodes.

In some cases, the approximately spherical or approximately elliptical shape of the volume-changing electrode particles may be configured to enhance the rate performance of the electrodes, improve stability of the electrodes, or a combination thereof. In an example, to further enhance rate performance of the electrodes comprising such particles, nearly all (e.g., over 80%) of the particles can be configured to be approximately the same in size (e.g., within +/−25%, within +/−10%, or even less to increase size uniformity). In an example, the particle size coefficient of variance is configured to be less than 0.2 (eg., less than 0.1, less than 0.05, etc.). In a further example, such a high size-uniformity may allow formation of colloidal crystal-like structure within the electrodes, and lead to the formation of aligned pores within densely packed spheres. In a further example, the average grain size dimensions of colloidal crystals in the electrode may exceed 10% of the electrode thickness (one side of the active electrode layer). In a further example, the average grain size dimensions of colloidal crystals in the electrode may exceed 20% of the electrode thickness, or 50% of the electrode thickness, or 75% of the electrode thickness.

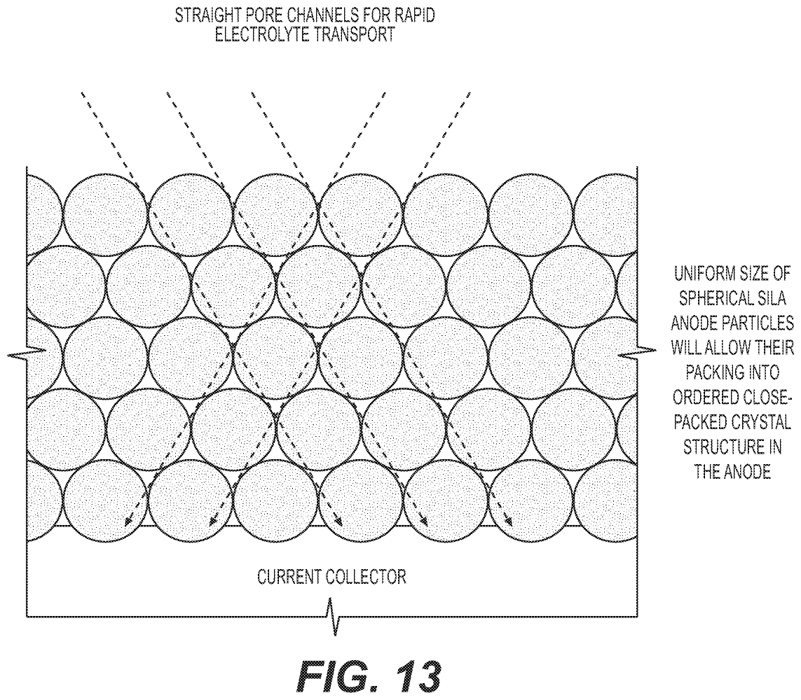

FIG. 13 illustrates a schematic example of one side of an electrode composed of individual near-spherical (nano)composite particles of substantially uniform dimensions, suitable amount and type of binder(s) and conductive additives in accordance with an embodiment of the disclosure. In the example of FIG. 13, the ordering of uniform near-spherical particles (e.g., into a close-packed colloidal crystal structures) results in the formation of straight pore channels. In this example, the average grain size of the colloidal crystal exceeds the electrode thickness.

In some designs, calendaring (densification) is applied to electrodes in order to form the colloidal crystal structure and reduce porosity in the electrodes. In some designs, less than 10 vol. % (in some cases less than 5 vol. %) of the binders and conductive additives (combined) is used in such electrodes to facilitate formation of the colloidal crystals during the electrode preparation. By contrast, in some applications, larger quantities of the binder (e.g., that may precipitate at the contact points between particles) and conductive additives may limit the mobility of settling particles and thus reduce or prevent the formation of close-packed colloidal crystal structures. In some designs, additional binder may be added after the calendaring to enhance electrode stability. In some designs, electrically charged moieties (e.g., of the same charge) are added to the particle surfaces to prevent their rapid agglomeration and thus allow sufficient time for their rearrangement into a close packed structure. In some designs, binders that exhibit high solubility in a slurry solvent are used in order to reduce or prevent their precipitation, which may obstruct particle packing into colloidal crystal structures. In some designs, sonication or vibration of the electrode is utilized during slurry drying to facilitate settling of the particles into a close-packed structure.

In some designs where higher volumetric capacity of the electrodes is desired, the particle size distribution may be adjusted so as to include spheres with radii of approximately 0.225 R_{main particles} and approximately 0.414 R_{main particles} to fill the tetrahedral and octahedral sites of a close-packed colloidal crystal structure, respectively, where R_{main particles} is the radius of the majority (by volume) active (nano)composite particles.

In some designs, low molecular weight (MW) polymers (e.g., polymers with a MW less than about 25,000) may be utilized as binders (or as porous fibers or sacrificial fibers and platelets) because such polymers are more readily deformable during calendaring (densification), exhibit higher solubility in solvents (e.g., slurry solvents) and may produce less foaming during slurry mixing (e.g., particularly in water-based slurries). Lower mechanical stability and higher swelling of such polymer binders may be countered later by cross-linking and chemical linking to active particles and current collectors.

In some designs, the porosity of the electrode can be controlled. For example, the electrode may be fabricated so as to have a lower electrode layer (near a current collector) that exhibits a higher porosity (lower density; e.g., by only containing monodispersed particles or by containing porous filler particles or sacrificial particles in the shape of a sphere, a fiber, a plate, etc.), while a higher electrode layer (near a surface/separator) exhibits lower porosity (e.g., by also containing smaller particles that fit into interstitial positions in colloidal crystal structure, etc.). In this case, stresses near the current collector foils may be reduced (e.g., during the formation cycles), which may benefit cell stability and reduce undesirable current collector (e.g., foil) expansion or fracture. Such an approach may improve maximum rate performance (for a given volumetric capacity), in some designs.

In some designs (e.g., where thicker electrodes are utilized or where volume changes are higher or where higher rate performance is desired for a particular application), straight pores (e.g., channels) to the electrode are used in order to improve electrode stability and rate performance. Such pores (e.g., channels) may be of a near-cylindrical shape, cone-shape, or slit-shape, to name a few examples. In an example, the size (e.g., average diameter, average thickness, etc.) of the pores may be less than 20% of the electrode thickness (e.g., less than 5% of the electrode thickness) to reduce a local capacity mismatch between the cathode and the anode. In an example, a suitable length of such pores may be in the range from about 20% of the electrode thickness to around 100% of the electrode thickness (e.g., from 50% to 100%). In an example, the volume fraction of such pores in the electrode may range from around 0.01% to around 20% of the electrode volume. In certain applications, a smaller pore volume (pore fraction) may be less effective for ion transport and stress accommodation, while larger pore volume may undesirably reduce electrode volumetric capacity. In some designs, such pores may be introduced to the electrode during calendaring (densification) by using a patterned calendaring surface (e.g., with a pattern of pillars or cones or flat walls, to give a few suitable examples). In some designs, such pores may be introduced to the electrode prior to complete drying (e.g., when some particles may still be easily re-arranged). In some designs, the pattern of the patterned calendaring surface may be applied to the current collector foil prior to electrode casting and removed (e.g., thus creating some pores) prior to electrode drying. In some designs, the pattern of the patterned calendaring surface may be produced of the sacrificial material (e.g., similar to the previously discussed sacrificial fibers or platelets) and may be removed by heating or dissolution in a solvent. In some designs, the pattern of the patterned calendaring surface may exhibit hexagonal symmetry, cubic symmetry, or rectangular or rhombic symmetry. The formation of regular (e.g., patterned) pores in the electrode may be achieved using approaches similar to those used in regular or soft lithography.

In some designs, the pores (e.g., channels) in the electrode may be produced via micro-machining (e.g., in a defined pattern). For example, micro-machining may be performed by a laser. In addition to improving stability (e.g., by accommodating volume expansion or by improving uniformity of the redox reactions during charge or discharge) and rate performance of the electrodes, formation of such pores allows for rapid and uniform electrolyte wetting by having paths through the electrode as opposed to just around outside edges. If lasers are used for micro-machining, the laser wavelength can be fine-tuned to facilitate removal of the active material. In some designs, a vacuum is utilized to reduce or prevent re-deposition of the laser-evaporated material onto the electrode. In some designs, an array of the fiber optics (e.g., as an array of micro lenses) may be utilized for laser-micromachining. In some designs, laser micromachining may be conducted roll-to-roll on the electrode. In some designs, the micromachining may be conducted on the same line as the calendaring (electrode densification). In some designs, the pore channels may be produced before and in some designs after calendaring. In some designs, calendaring can be conducted twice—e.g., once before the pore channel formation and once after the pore channel formation.

As briefly discussed above, such pore channels can be configured to be straight (e.g., cylindrical) and propagate from the top surface of the electrode to close to the surface of the current collector (or at least close to a current collector, e.g., within less than 50% of the total thickness of one side of the electrode). In some designs, the pores (e.g., channels) in the electrode may extend all the way through the current collector (creating a through-hole). In an example, the total amount of material removed by the pore channels may be kept below a threshold of the total electrode mass (e.g., less than 10% of the total electrode mass, less than 5% of the total electrode mass, etc.). In an example, a smallest dimension or critical dimension (e.g., average diameter in the case of cylindrical or pyramid channels or average thickness in the case of slit-shaped channels) of such micro-machined channels may be less than 20% of the electrode thickness (e.g., less than 5% of the electrode thickness) to reduce a local capacity mismatch between the cathode and the anode.

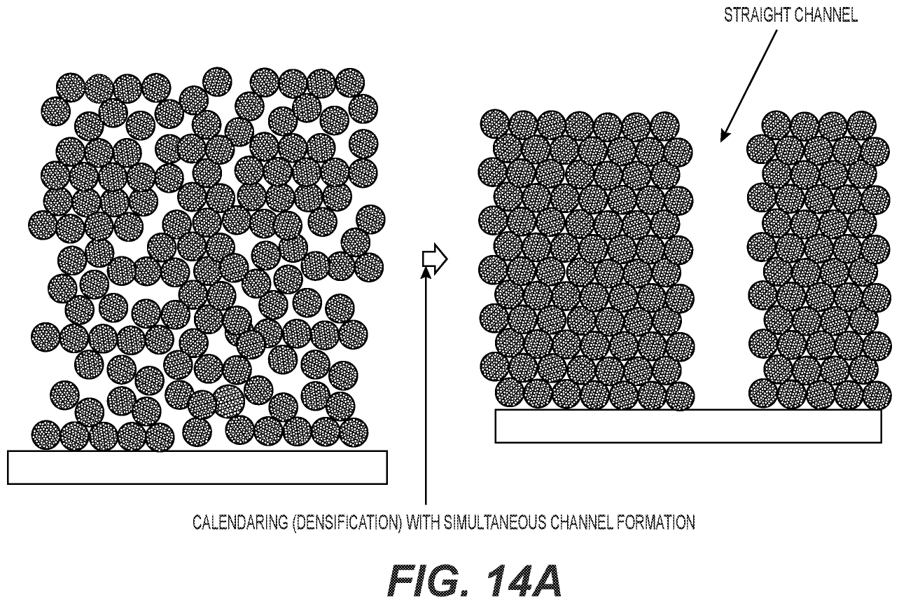

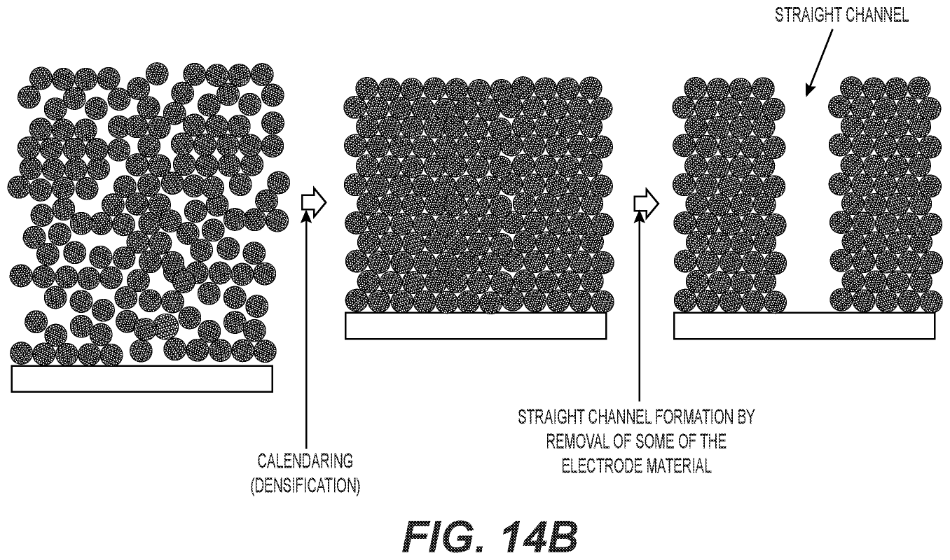

FIGS. 14A and 14B provide illustrative examples for the formation of an electrode comprising straight pores (e.g., channels) and colloidal crystals structure of near-spherical active material particles in accordance with an embodiment of the disclosure.

In some designs, to further improve energy density of the cells or improve the rate of cell assembly, the separator composition and microstructure may be improved.

In some designs, separators may be die-cut prior to using them in cell assembling (and stack it in a multi-layered pouch cell instead of rolling it around individual electrodes).

In one example, additives (e.g., ceramic additives) are added to the polymer (e.g., of the polymer separator) in order to increase its dielectric constant in order to make it easier to pick a cut separator sheet up during cell assembly using an electrostatic gripper. This may be advantageous in certain applications because (i) separators may be sufficiently porous and sufficiently thin (e.g., to allow rapid ion transport in a cell) such that vacuum pickup is either ineffective or picks up a whole stack of separator sheets (e.g., because they may adhere to each other, e.g., due to Van der Waals or electro-static or other forces); (ii) vacuum chucks may damage the separator locally (e.g., particularly where the pores are); and (iii) vacuum grippers are dust-prone, which may undesirably bring dust into an assembled cell stack.

In another example design, a conductive layer is added to one of the surfaces of the separator to reduce electrostatic interactions with other separators. Such a layer may be deposited by, for example, by spraying or sputtering or thermal evaporation, by a combination thereof, or by other mechanisms.

In some designs, a layer of magnetic material is added (e.g., to one of the surfaces of the separator) to be able to utilize a magnetic gripper (e.g., electromagnet) on a cut separator sheet, which is functions somewhat similarly to an electrostatic gripper.

In some designs, a 98-100% ceramic separator is used (e.g., comprising ceramic (e.g., aluminum oxide, zirconium oxide, magnesium oxide, etc.) nanofibers or ceramic nanowires that are relatively thin (e.g., less than 20 microns) and flexible (e.g., having a bend radius less than 1 cm)). In certain applications, ceramic is more robust compared to a polymer and thus may better withstand volume change-induced stresses.

In some designs, at least one of the electrodes is coated with a layer of the ceramic nanofibers or nanowires (e.g., with the layer thickness in the range from about 50 nm to about 15 micron; most commonly in the range from about 200 nm to about 7 micron). In some designs, thermally stable polymer fibers (e.g., aramid fibers) with Tg above 250° C. may be used instead of, or in addition to, the ceramic nanofibers. In some designs, porous ceramic flakes may be used instead of or in addition to the ceramic fibers. In some designs, such a layer may comprise 0-60 wt. % of the polymer binder or a polymer electrolyte. In certain applications, such an approach may enhance safety and/or may improve rate performance and stability of the cell. In some designs, such a coating may be deposited by using a tape-casting process or by using a spray. In some designs, the coating may be deposited on pre-cut electrodes.

In some designs, ceramic nanofibers or nanowires may be incorporated in a polymer matrix of a separator to produce a polymer-ceramic composite separator (e.g., with a polymer content of less than vol. 80%; in some designs, with a polymer content of less than 60 vol. % in other designs, etc.). In some designs, a ceramic separator may be coated with a thin (e.g., 1-1,000 nm) layer of a polymer (e.g., either conformably or on the top surface).

In some designs of polymer-ceramic composites, the separator is configured to exhibit a low open porosity (e.g., by filling the pores between ceramic fibers or closing the separator from one surface by laminating) to facilitate vacuum suction by a vacuum suction gripper. In some designs, a polymer layer that may dissolve into electrolyte is added to the separator in order to make the separator more permeable to electrolyte. Alternatively, this polymer layer may be sacrificial and may be removed after stack assembling (e.g., by exposure to a solvent or by a thermal treatment). Salts, sugars and/or solvents may also be used as sacrificial (temporary) pore closers (pore fillers) to improve handling of the separator by a vacuum suction gripper.

In some designs, a separator layer may be heat-laminated onto an electrode (e.g., an anode) prior to electrode cutting. In this case, there may be no need to separate separator membrane handling. In some designs, the laminating (e.g., polymer) layer may be soluble in electrolyte solvent.

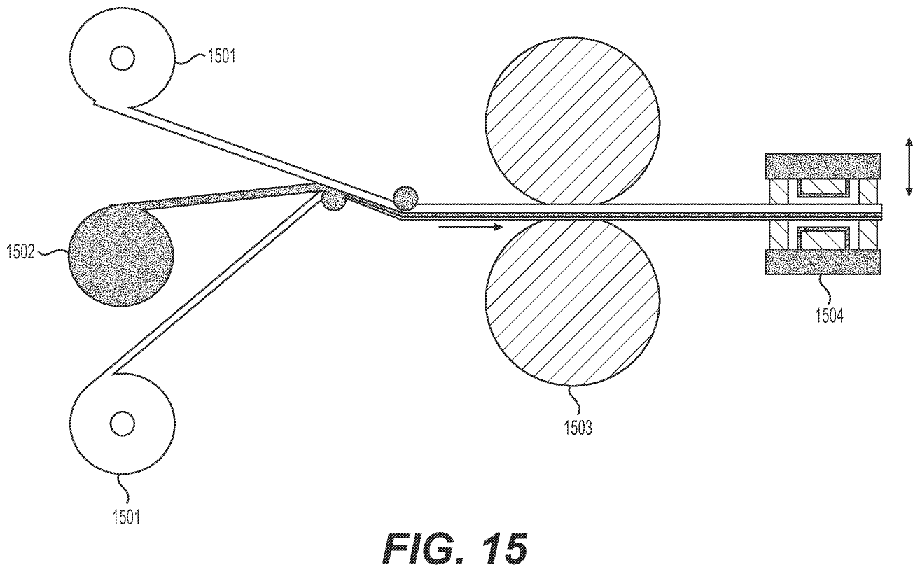

In some designs, an electrode may be laminated with the separator layers prior to cell assembling. FIG. 15 illustrates an example process, where two rolls of the separator 1501 are laminated together on both sides of the electrode 1502 using a calendaring tool 1503. A polymer layer (a glue) may be utilized to improve adhesion between the separator layers and the electrode. The calendaring (lamination) tool may apply temperature (e.g., from around room temperature to around 100° C.) and pressure to achieve a desired level of uniformity, density and/or adhesion between the layers. The separator-aminated electrodes may be cut (e.g., using a cutting tool 1504) prior to cell assembling.

In some designs, a separator may be directly deposited onto the surface of at least one of the electrodes (e.g., in the case of metal-ion (such as Li-ion) batteries, onto the electrode with larger lateral dimensions, i.e., the anode). In some designs, the separator may comprise elongated (e.g., one-dimensional) particles with a diameter less than 1 micron (e.g., nano-fibers or nanotubes or nanowires). In some designs, such particles may exhibit an aspect ratio in excess of 10 and a length exceeding the diameter of the (nano)composite particles. In some designs, such particles may be more than 5 microns in length. In some designs, porous or ionically conductive flake-shaped particles may be used instead of the fibers. In some designs, some of the particles may be bonded to each other.

In some designs, the separator layer may comprise ceramic nanofibers, nanotubes, nanowires, nanoflakes or nanoparticles. As previously briefly mentioned, in some designs, the separator layer may be deposited onto the electrode surface before the electrode is calendered (densified/compressed). In some designs, the separator layer may be deposited onto the electrode surface before the electrode is fully dried. In this case, it may be better integrated into the electrode structure and may exhibit better adhesion. In some designs, the separator layer may be deposited onto the electrode surface by a spray coating method or by a casing method (e.g., from a separator slurry solution or suspension).

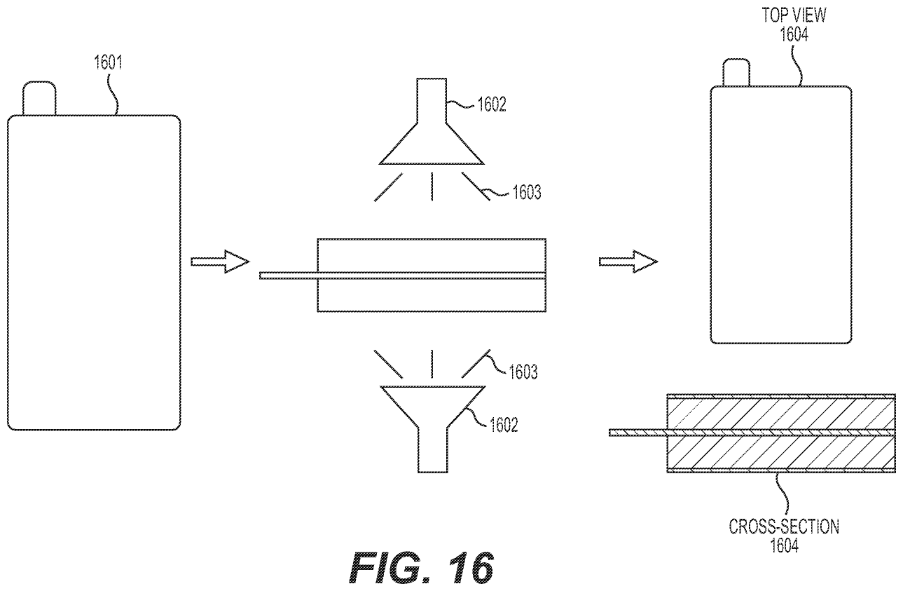

FIG. 16 illustrates an example process, where a pre-cut electrode 1601 is coated on both sides with ceramic (or stiff polymer) nanofibers or nanowires or porous flake-like particles 1603 using a sprayer 1602 to produce a coated electrode 1603. For simplicity of illustration, the cross-section schematically shows that the fiber/nanowire/flake particle coating is mostly located on the top and bottom of the electrode. However, in some applications, it may be beneficial if the coating layer is also deposited on the sides of the electrode for improved safety. In some designs, the coated electrode may be additionally dried or calendared prior to using in cells.

In some designs, the overall average thickness of the deposited separator layer may range from about 0.05 to about 25 microns (e.g., from about 0.2 to about 15 microns, depending on the roughness of each electrode and the volume changes in each electrode; larger roughness or volume changes may require a larger separator thickness and better mechanical properties).

In some designs, the separator (or a separator layer) may form chemical (e.g., covalent) bonds with one of the electrodes.

In some designs, a porous separator (or individual fibers of the porous separator) may be impregnated with strong magnetic or strong dielectric materials.

In some designs, separators with tensile isotropy are used to facilitate die-cutting and separator handling. In certain applications, the separators may rip more easily along the grain direction but not across the grain, which complicates rectangular cuts of certain commercial separators. By making the polymer less stringy in the down-web direction, die-cutting separator rectangles may be simplified.

In some designs, separators are cut either at low temperatures (e.g., below the glass transition temperature of polymer separator) or at higher speeds.

In some designs, to facilitate more effective laser cutting of the separators, additives that are sensitive to the laser wavelength may be used.

In some designs, pigments (e.g., dyes or quantum dots) are added to the separator (or separator surface) to facilitate machine-vision-based control of separator placement (e.g., certain commercial separators are white and filmy, making it difficult to pick up on a camera).

In some designs, additives are added or incorporated into the separator to facilitate non-optical imaging (e.g., metal-comprising (e.g., barium and others) additives), which in turn facilitates in-situ non-invasive diagnostics (e.g., x-ray tomography, etc.) on assembled cells.

In various embodiments of the present disclosure, nanocomposite particles may generally be of any shape (e.g., near-spherical, cylindrical, plate-like, have a random shape, etc.) and of any size. The maximum size of the particle may depend on the rate performance requirements, on the rate of the ion diffusion into the partially filled particles, and on other parameters.

Some aspects of this disclosure may also be applicable to conventional intercalation-type electrodes and provide benefits of improved rate performance or improved stability, particularly for electrodes with medium and high capacity loadings (e.g., greater than 3 mAh/cm²).

This description is provided to enable any person skilled in the art to make or use embodiments of the present disclosure. It will be appreciated, however, that the present disclosure is not limited to the particular formulations, process steps, and materials disclosed herein, as various modifications to these embodiments will be readily apparent to those skilled in the art. That is, the generic principles defined herein may be applied to other embodiments without departing from the spirit or scope of the present disclosure.

1. A Li-ion battery anode, comprising:
a current collector; and
an electrode layer arranged on the current collector, the electrode layer comprising composite particles and a binder mixed with the composite particles, the binder adhering to the composite particles, the composite particles adhering to the current collector,
wherein:
the composite particles comprise carbon and silicon and exhibit an average particle size in a range from about 0.2 μm to about 40 μm;
the Li-ion battery anode exhibits an average areal capacity loading in a range of about 2 mAh/cm² to about 10 mAh/cm²; and
the binder comprises a copolymer comprising an acrylamide subunit and a second subunit selected from an acrylic acid, a carboxylic acid, an alginic acid, and a metal salt of any of the foregoing.

2. The Li-ion battery anode of claim 1, wherein the electrode layer exhibits a volumetric capacity in a range of about 600 mAh/cc to about 1800 mAh/cc.

3. The Li-ion battery anode of claim 2, wherein the volumetric capacity is in a range of about 700 mAh/cc to about 1400 mAh/cc.

4. The Li-ion battery anode of claim 1, wherein the composite particles exhibit a specific capacity in a range from about 600 mAh/g to about 2000 mAh/g.

5. The Li-ion battery anode of claim 1, wherein the composite particles comprise nanostructured or nano-sized silicon particles.

6. The Li-ion battery anode of claim 1, wherein the composite particles comprise carbon coatings.

7. The Li-ion battery anode of claim 1, wherein the copolymer is water-soluble.

8. The Li-ion battery anode of claim 1, wherein the copolymer is characterized by a molecular weight (MW) of less than about 25,000.

9. The Li-ion battery anode of claim 1, wherein the metal is selected from Na, K, Ca, Mg, Li, Sr, Cs, Ba, and La.

10. The Li-ion battery anode of claim 1, wherein the copolymer comprises halide anions.

11. The Li-ion battery anode of claim 1, wherein the copolymer comprises ammonium cations.

12. The Li-ion battery anode of claim 1, wherein the copolymer comprises diallyldimethylammonium chloride (DADMAC), diallyldiethylammonium chloride (DADEAC), methylammonium chloride, N,N-diallyl-N-propylammonium chloride, methylammonium bromide, ethylammonium bromide, propylammonium bromide, butylammonium bromide, methylammonium fluoride, ethylammonium fluoride, propylammonium fluoride, and/or butylammonium fluoride.

13. The Li-ion battery anode of claim 1, wherein an amount of the second subunit in the copolymer is less than around 10 wt. %.

14. The Li-ion battery anode of claim 1, wherein the electrode layer comprises conductive additive particles.

15. The Li-ion battery anode of claim 14, wherein the conductive additive particles comprise carbon.

16. The Li-ion battery anode of claim 14, wherein the conductive additive particles are elongated.

17. The Li-ion battery anode of claim 14, wherein the conductive additive particles comprise single-walled carbon nanotubes.

18. The Li-ion battery anode of claim 14, wherein the electrode layer comprises less than 2 wt. % of the conductive additive particles.

19. The Li-ion battery anode of claim 1, wherein the current collector is a metal foil with an average thickness in a range from around 4 μm to around 15 μm.

20. The Li-ion battery anode of claim 1, wherein the current collector is an electrodeposited metal foil.

21. The Li-ion battery anode of claim 1, wherein the current collector is a copper (Cu) alloy foil comprising less than 99 wt. % copper (Cu).

22. The Li-ion battery anode of claim 1, additionally comprising a conductive interlayer between the current collector and the electrode layer.

23. The Li-ion battery anode of claim 22, wherein:
the binder of the electrode layer is a first binder;
the conductive interlayer comprises a second binder; and
the second binder comprises the copolymer.

24. The Li-ion battery anode of claim 22, wherein:
the binder of the electrode layer is a first binder;
the conductive interlayer comprises a second binder; and
the second binder comprises a poly(vinyl alcohol).

25. The Li-ion battery anode of claim 22, wherein:
the binder of the electrode layer is a first binder;
the conductive interlayer comprises a second binder; and
the second binder comprises a second copolymer comprising a second acrylamide subunit and a third subunit selected from a second acrylic acid, a second carboxylic acid, a second alginic acid, and a second metal salt of any of the foregoing.

26. The Li-ion battery anode of claim 22, wherein the conductive interlayer comprises elongated conductive particles.

27. The Li-ion battery anode of claim 26, wherein the elongated conductive particles comprise single-walled carbon nanotubes.

28. A Li-ion battery comprising:
the Li-ion battery anode of claim 1;
a cathode;
a separator interposed between the Li-ion battery anode and the cathode; and
an electrolyte impregnating the separator,
wherein:
the composite particles exhibit volume expansion in a range of about 8 vol. % to about 160 vol. % during a first charge-discharge cycle and volume expansion in a range of about 4 vol. % to about 50 vol. % during one or more subsequent charge-discharge cycles.

29. The Li-ion battery of claim 28, wherein:
the Li-ion battery exhibits a specific capacity in a range from about 500 mAh/g to about 3000 mAh/g.
